(19) United States
(12) Patent Application Publication
(10) Pub. No.: US 2010/0125947 A1
(43) Pub. Date: May 27, 2010

(54) LEG LIFTING APPARATUS

(75) Inventor: Wayne Smeaton Manson, Auckland (NZ)

Correspondence Address: YOUNG & THOMPSON, 209 Madison Street, Suite 500, Alexandria, VA, 22314, US

(73) Assignee: MUKTIFIT HOSPITAL SUPPLIES LIMITED, AUCKLAND (ZA)

(21) Appl. No.: 12/520,304

(22) PCT Filed: Dec. 19, 2007
(86) PCT No.: PCT/NZ07/00375

§ 371 Date: Jun. 19, 2009

(30) Foreign Application Priority Data
Dec. 9, 2006 (NZ) 552237

(51) Int. Cl. A61G 7/053

(52) U.S. Cl. 5/83.1

(57) ABSTRACT

A leg lifter allows a disabled person's legs to be moved onto or off a bed. The apparatus uses a single actuator acting via a control arm to perform the lateral and pivoting movements required to move a leg support member from a lowered position to a raised position.

### FIELD

This invention relates to apparatus for moving or transporting a user's legs onto, or off, a bed. The invention is particularly applicable to disabled and elderly persons.

### BACKGROUND

Persons with certain disabilities have difficulty lifting or otherwise moving their legs onto a bed, or an object functioning as a bed, so that they may rest. Similarly, once on a bed in a prone position a disabled user may have difficulty removing his or her legs from the bed. Such persons can usually sit on the edge of a bed, but the act of lifting their legs onto (and sometimes off) the bed is difficult or impossible without human or mechanised assistance.

Products that attempt to address this problem are commonly referred to as “leg lifters”, “bed leg raisers” or “powered leg lifters”. These products take a variety of forms and typically function to lift the user's legs so that the user can then shuffle or otherwise manoeuvre his or her legs laterally onto and across the bed until the user's legs are fully supported by the bed in a position in which the user can comfortably sleep. The physical apparatus used to perform this function is typically large, unwieldy, complex and difficult to install.

Furthermore, the user's disability is frequently such that, even if the user's legs are lifted into a position adjacent to the upper surface of the bed, it is very difficult or impossible for the user to move his or her legs laterally onto the bed.

The applicant's published International Patent Application No. PCT/NZ2003/000033 entitled “LEG MOVEMENT APPARATUS AND METHOD”, the contents of which are herein incorporated by reference, describes an apparatus and method for transporting a user's leg(s) between a position adjacent to an upper side of the bed and a position on an upper surface of the bed.

This apparatus works in two stages using two or more actuators and a system of pulleys to first raise the users legs from a sitting position at the side of the bed, to a substantially horizontal position adjacent to the upper surface of the bed, then moving the users legs transversely with respect to the bed towards the centre of the upper surface. This system can work very effectively but it is relatively complex and expensive to manufacture.

### OBJECT OF THE INVENTION

It is an object of the invention to provide leg transport apparatus or methods for transporting or moving a users leg(s) onto or off a bed which ameliorates one or more disadvantages of known constructions.

Alternatively it is an object of the invention to provide leg transport apparatus or methods for transporting or moving a user's leg(s) onto or off a bed which will at least provide the public with a useful choice.

Further objects of the invention will become apparent from the following description.

### SUMMARY OF INVENTION

Accordingly in one aspect the invention consists in leg transport apparatus for transporting or moving a user's leg(s) onto or off a bed, the apparatus comprising
a support frame adapted to attach to a bed, or comprising part of a bed;
a leg support for supporting the leg(s) of a user, the leg support having a leg support surface and being slidably and pivotally mounted relative to the support frame;
an actuator means operable to move the leg support slidably relative to the support frame; and
a control arm pivotally connected between the leg support and the support frame whereby slidable movement of the leg support relative to the support frame causes pivotal movement of the leg support relative to the support frame such that the leg support can be disposed in a lowered position in which the leg support surface is substantially vertical for receiving the lower leg(s) of a user, and a raised position in which the leg support surface is substantially horizontal and laterally displaced from the lowered position to dispose the leg(s) of a user substantially adjacent to or on an upper surface of a bed.

In a further aspect the invention consists in a method for transporting or moving a user's leg(s) onto or off a bed, the method comprising providing a leg support on which the user rests his or her leg(s), and moving the leg support between a first generally vertical lowered position adjacent to a lower side of the bed and a generally horizontal raised position adjacent to an upper surface of the bed using a single actuator.

In a further aspect the invention consists in a bed including a leg transport apparatus, the apparatus comprising:
a stationary support comprising part of the bed;
a leg support for supporting the leg(s) of a user, the leg support having a leg support surface and being slidably and pivotally mounted relative to the support frame;
an actuator means operable to move the leg support slidably relative to the support frame; and
a control arm pivotally connected between the leg support and the support frame whereby slidable movement of the leg support relative to the support frame causes pivotal movement of the leg support relative to the support frame such that the leg support can be disposed in a lowered position in which the leg support surface is substantially vertical for receiving the lower leg(s) of a user, and a raised position in which the leg support surface is substantially horizontal and laterally displaced from the lowered position to dispose the leg(s) of a user substantially adjacent to or on an upper surface of a bed.

In a further aspect the invention consists in leg transport apparatus for transporting or moving a user's leg(s) onto or off a bed, the apparatus comprising a leg support on which the user rests his or her leg(s), the leg support being moveable between a first generally vertical lowered position adjacent to a lower side of the bed and a generally horizontal raised position adjacent to an upper surface of the bed using a single actuator.

The invention also broadly consists in any novel feature (or the equivalent of that feature if not expressly stated) or novel combination of features (or equivalents) disclosed herein.

### DRAWING DESCRIPTION

A number of embodiments of the invention will now be described by way of example with reference to the drawings in which:

FIG. 1 is a plan view of a first embodiment of a leg lifting apparatus according to the invention.

FIG. 1a is a simplified plan view of the first embodiment showing the control arm in a partially extended lowered position.

FIG. 1b is a further view of the apparatus shown in FIG. 1a but showing the control arm in a non-extended lowered position.

FIG. 2 is a side view of the embodiment of FIG. 1.

FIG. 3 is a reverse, side view of the leg lifting apparatus of FIGS. 1 and 2.

FIG. 4 is an end view of the embodiment of FIGS. 1-3.

FIGS. 5a and 5b are end and side elevations of a leg lifting apparatus according to the invention, shown attached to a bed at the fully lowered position of operation.

FIGS. 6a and 6b are end and side elevations of the leg lifting apparatus of FIGS. 5a and 5b, shown at an intermediate position of operation.

FIGS. 7a and 7b are end and side elevations of the leg lifting apparatus of FIGS. 5a-6b, shown at a fully raised position of operation.

FIG. 8 is a front elevation of an alternative embodiment of a leg support member according to the invention, in a retracted position.

FIG. 9 is a front elevation of the leg support of FIG. 16 in an extended position.

FIG. 10 is a plan view of a further embodiment of a leg lifting apparatus according to the invention, incorporating an alternative leg support member shown in a retracted position.

FIG. 11 is a plan view of the leg lifting apparatus of FIG. 8 with the leg support in an extended position.

FIGS. 12a and 12b are side and end elevations of a further embodiment of the invention including an optional bed grab handle.

FIGS. 13a and 13b are side and end elevations of a further embodiment of the invention including an optional transfer rail.

FIGS. 14a and 14b are partial side elevations of a further embodiment of the invention fitted to a profiling bed.

FIG. 15 is a side elevation of leg lifting apparatus according to a further embodiment of the invention.

FIG. 16 is a partial end elevation of the apparatus of FIG. 15 with a stability bar attached.

FIG. 17 is a diagrammatic partial end elevation of the apparatus of FIG. 15 including a stability bar shown in use on a bed.

FIG. 18 is a partial side elevation of a profiling bed including leg lifting apparatus according to FIG. 15.

FIG. 19 is a side elevation of the leg lifting apparatus of FIG. 15 attached to a profiling bed.

FIG. 20 is an end elevation of the apparatus of FIG. 19.

FIGS. 21A-21C are an end elevation, side elevation and plan view respectively of a handrail for attachment to the leg lifting apparatus of bed of the preceding figures.

FIG. 22A is a plan view of an extendable leg support assembly for selective use with the leg lifting apparatus of the preceding FIGS., with the leg support in an extended position.

FIG. 22B is a plan view of the apparatus of FIG. 22A in a retracted position.

FIG. 23 is an end view of FIG. 22B.

FIG. 24A is a side view of FIG. 22B.

FIG. 24B is a partial side view of FIG. 22B showing hinge detail.

FIG. 25 is a side elevation of the apparatus of FIG. 15 including the leg support assembly of FIGS. 22A to 24B with the leg support in a lowered position.

FIG. 26 is a side elevation of the apparatus of FIG. 15 including the leg support assembly of FIGS. 22A to 24B with the leg support in a raised position.

### DETAILED DESCRIPTION OF THE DRAWINGS

Throughout the description like reference numerals will be used to refer to like features in different embodiments.

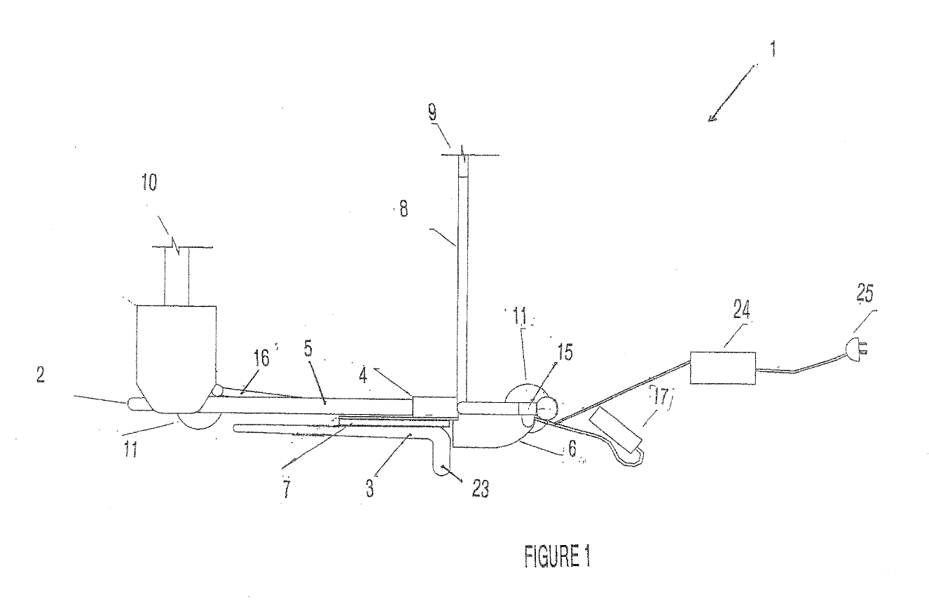

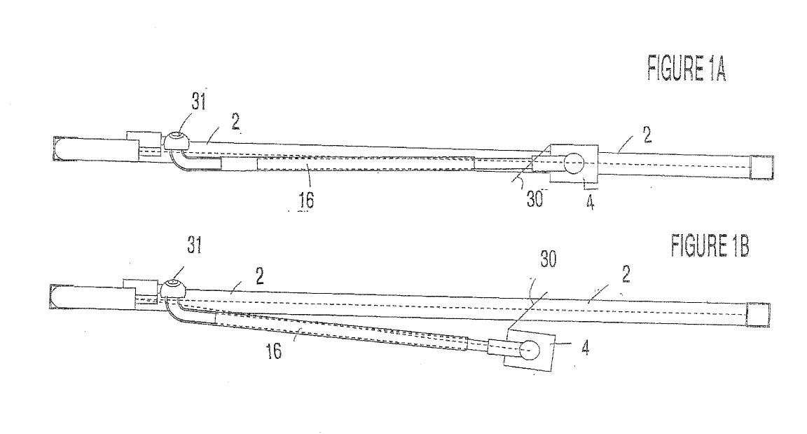

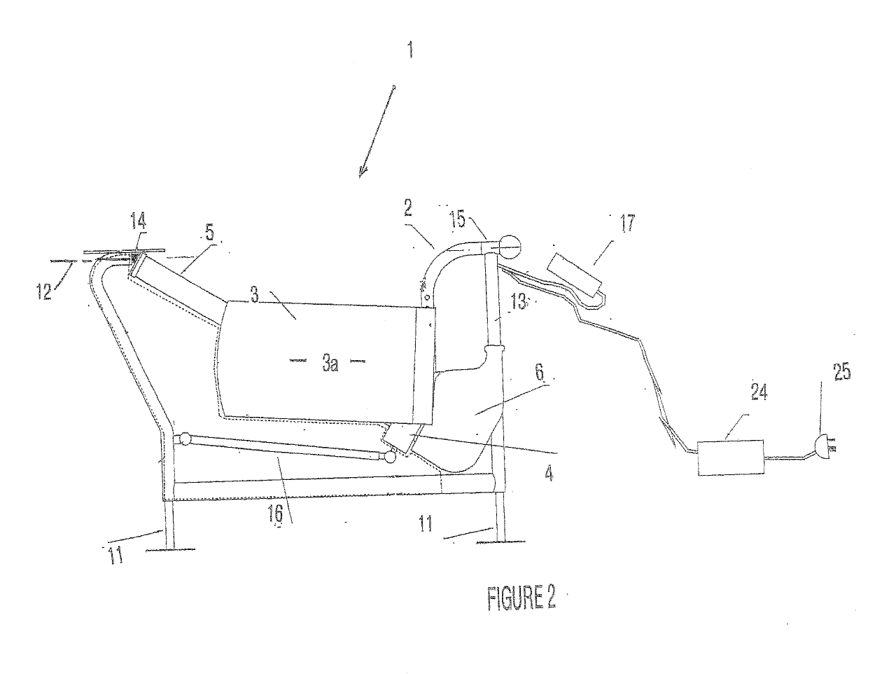

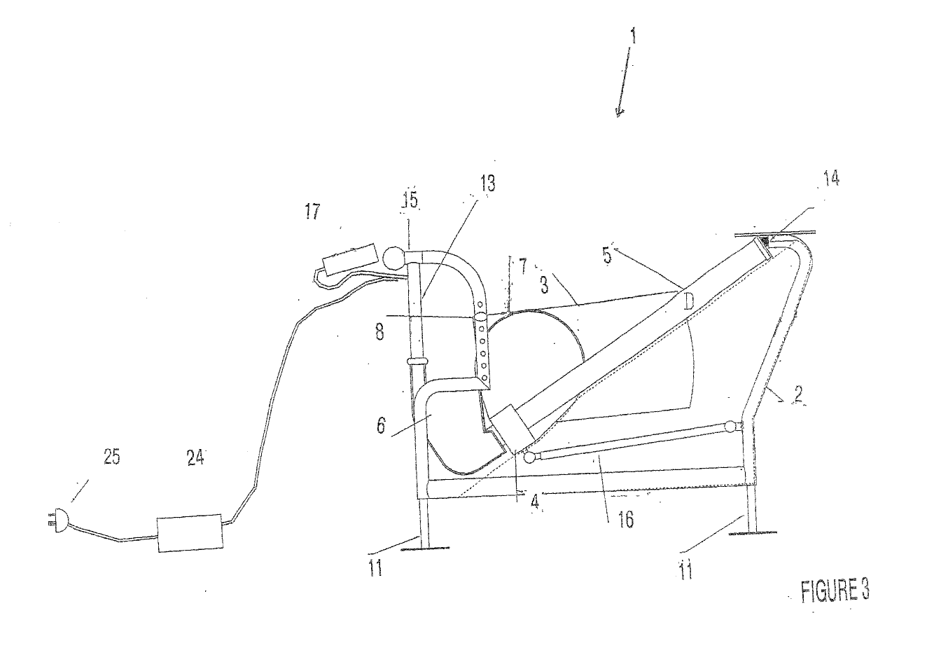

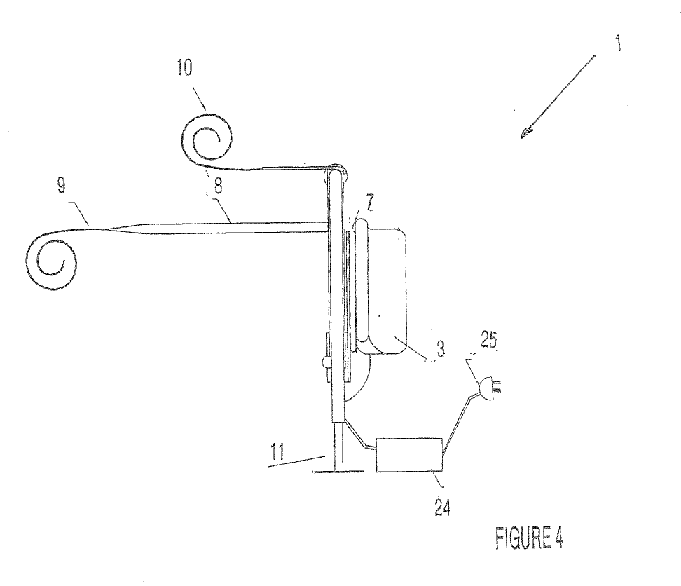

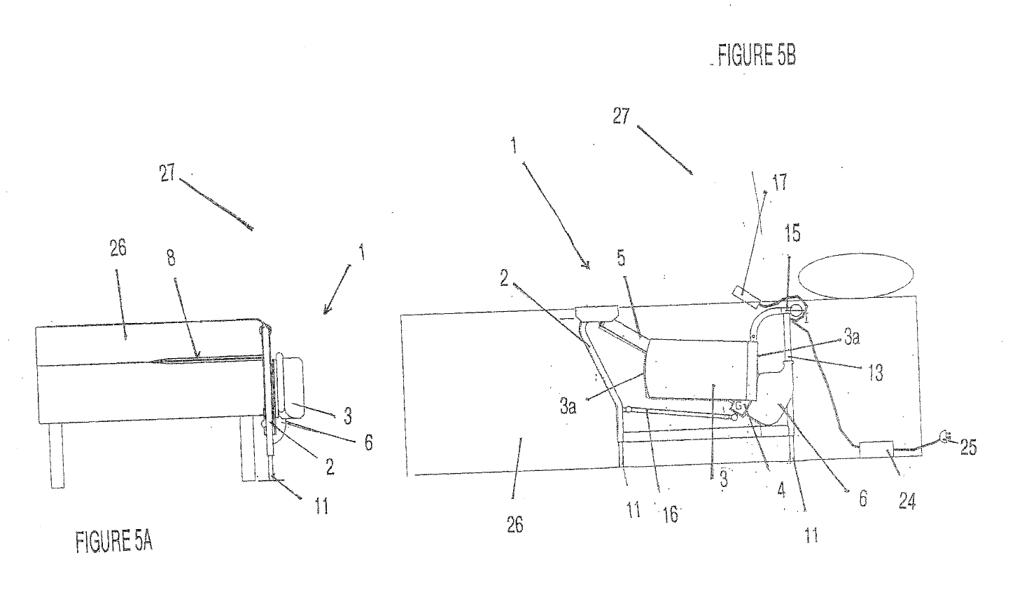

Referring first to FIGS. 1 to 4, the invention provides a first embodiment of a leg transport apparatus, generally referenced 1, for transporting or moving a user's leg(s) onto or off a bed. The various embodiments of leg transport apparatus described herein will be referred to generally as bed leg raising apparatus for purposes of convenience.

The apparatus comprises a transport means pivotally connected to a base support frame support 2 which is stationary in use and adapted to be connected to, or part of, a mattress base or bed frame. The transport means is adapted to move a leg support between a fully lowered position of operation, wherein the leg support is generally vertical and adjacent to a side of the bed, and a fully raised position, wherein the leg support is substantially horizontal and adjacent to or on an upper surface of the bed. The apparatus is shown in the fully lowered position of operation.

The base support frame 2 is provided with a height-adjustable stability bar 8 and one or more straps to secure the apparatus 1 to the side of the bed, in the illustrated embodiment, the stability bar 8 is in practice placed between the base and mattress of the bed. Because the stability bar 8 is positioned under the mattress approximately where a user would sit during use of the apparatus 1, the downward pressure of the user on the stability bar counteracts the torque created by the weight of the users legs on the leg support during use.

The top strap 9, extending from the end of the stability bar 8, may be looped around under the bed base and secured to the base frame 2. Similarly, the bottom strap 10 may be extended across the upper surface of the bed and looped around between the mattress and the bed base, and secured to the base frame 2. To provide further support, the apparatus 1 also includes height-adjustable feet 11 to accommodate differing bed heights.

In this embodiment, the leg support, in the form of a footrest 3 in the example illustrated, is pivotally mounted to the transport means via a “lazy suzy” swivel bearing 7 which allows the footrest 3 to rotate, within limits, about an axis that is generally perpendicular to the plane of the transport means.

The transport means preferably comprises guide means such as a linear guide 5, a carriage 4, and an actuation means to move the carriage 4 relative to the linear guide 5. The guide 5 may be curved if desired. In use, a control system in the form of a wired or wireless remote control handset 17 is provided which allows the user to control the operation of the actuation means.

In a preferred embodiment, the actuation means comprises an electric motor 6 and a driving means. The electric motor 6 is adapted to be powered by mains electricity from a wall outlet and therefore includes an electrical plug 25 suitable to be coupled with a mains electricity wall outlet, and a transformer 24 to convert the mains electricity to the current and voltage required by the electric motor 6. In other embodiments the actuator may be powered by a battery.

In the illustrated embodiments, the driving means comprises a worm drive comprising a threaded rod provided within the linear guide 5, and through a complementary threaded portion of the carriage 4, in a self-locking worm drive arrangement. In practice, the electric motor 6 is used to rotate the threaded rod about its longitudinal axis, causing the carriage 4 to move relative to the linear guide 5. Although a worm drive is disclosed, it will be appreciated that the driving means may alternatively comprise a pulley system, an alternative gear drive such as a chain drive or a tooth and sprocket drive arrangement, or any other such suitable driving means.

In this embodiment the linear guide 5 is pivotally connected directly to the base frame 2 at region 14, while the second end is offset from the axis of rotation 12 by a lift arm 13, which is pivotally connected to the base support frame 2 at region 15. Together, the linear guide 5 and lift arm 13 form a moveable frame part. A control arm 16 is pivotally connected between the carriage 4 of the moveable frame part, and the stationary base support frame 2 such that movement of the carriage 4 relative to the linear guide 5 causes the moveable frame part to move pivotally relative to the stationary support about the pivot joints 14 and 15. Those skilled in the art will appreciate that the control arm may be connected to another part of the moveable frame that moves with the carriage.

Therefore, as the actuator moves the carriage along the guide means, the control arm causes the moveable frame part to pivot, thus moving the user's legs upwardly or downwardly while they are also being moved laterally in a direction along a longitudinal axis of the bed or support frame. When the carriage is moved longitudinally toward pivot 14, arm 16 forces the arm 13 to rise, pivoting arm 13 away from the stationary support frame. This raises the user's leg(s). When the carriage is moved away from pivot 14, arm 13 pivots back towards the stationary support frame, thus lowering the user's leg(s). Therefore, slidable movement of the leg support relative to the support frame by the actuator causes pivotal movement of the leg support relative to the support frame such that the leg support can be disposed in a lowered position in which a leg support surface 3a of the leg support is substantially vertical for receiving the user's lower leg(s), and a raised position in which the leg support surface is substantially horizontal and laterally displaced from the lowered position to dispose the leg(s) of a user substantially adjacent to an upper surface of a bed. From the raised position the user may shuffle his or her leg(s) onto a middle part or central part of the upper surface of the bed.

Referring now to FIGS. 1a and 1b, it can be seen that the stationary support frame 2 includes a ramp portion 30. As shown in FIG. 1a, when the arm 13 is in the lowered position the carriage 4 moves along the ramp portion and the control arm 16 extends, allowing arm 13 to fold into position within the stationary frame 2. Upon actuation of the actuator, the carriage 4 moves along the ramp portion. This moves the control arm 16 outwardly about spherical bearing 31, and causes it to retract to a non-extended position as shown in FIG. 1b. Thus the control arm is positioned at an opening angle to allow it to act to control the upward pivoting movement of the arm 13. The opening angle in the embodiment shown is approximately 6 degrees. Those skilled in the art will appreciate that an opening angle is required for the control arm to exert an outward force on arm 13. Those skilled in the art will also appreciate that the opening angle may be achieved ways other than using a ramp. For example, a can could also be used.

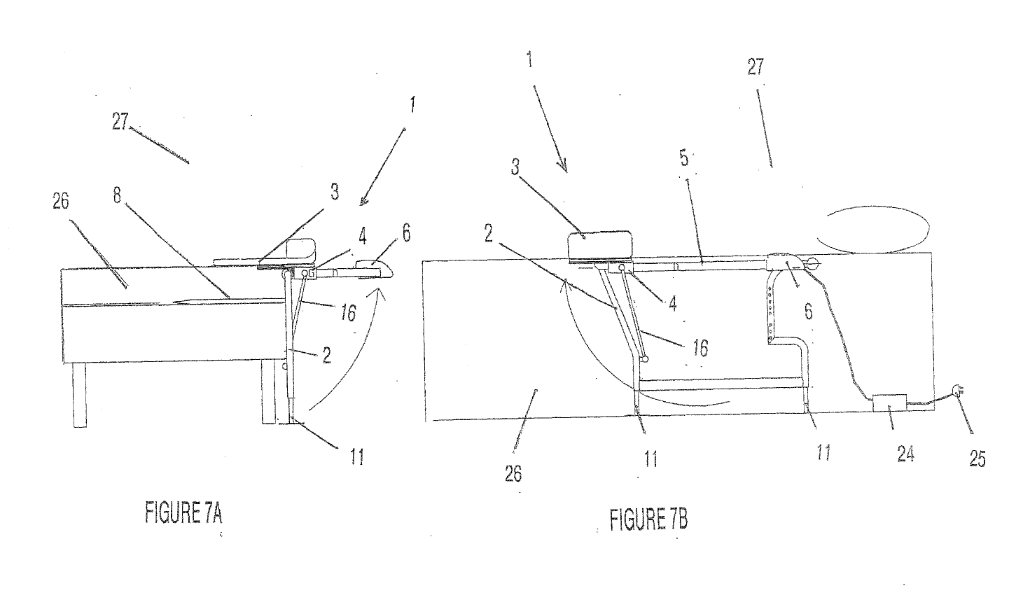

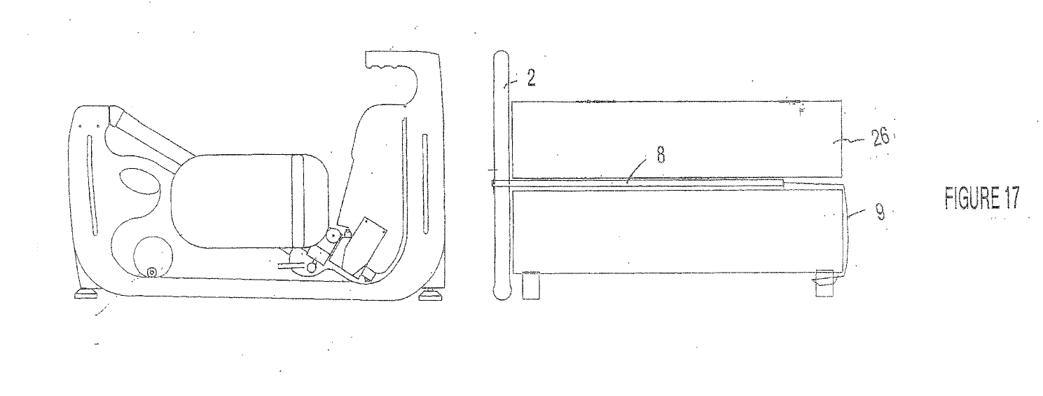

Referring now to FIGS. 5a-7b, the apparatus 1 is illustrated in use, shown diagrammatically in conjunction with a bed, referenced 26, and a user of the apparatus, referenced 27. The user may sit on the bed as shown, placing his or her legs such that the user's feet or lower legs are in front of the leg support or footrest 3 in its lowered position. Upon the user issuing an operating command (such as by pressing a button to activate a switch) using the remote control handset 17, the actuator is activated which causes the footrest 3 to move from the lowered vertical position as shown in FIGS. 5a and 5b, through a natural range of motion a person would ordinarily use, to the fully raised horizontal position adjacent to or on the upper surface of the bed, as shown in FIGS. 17a and 17b.

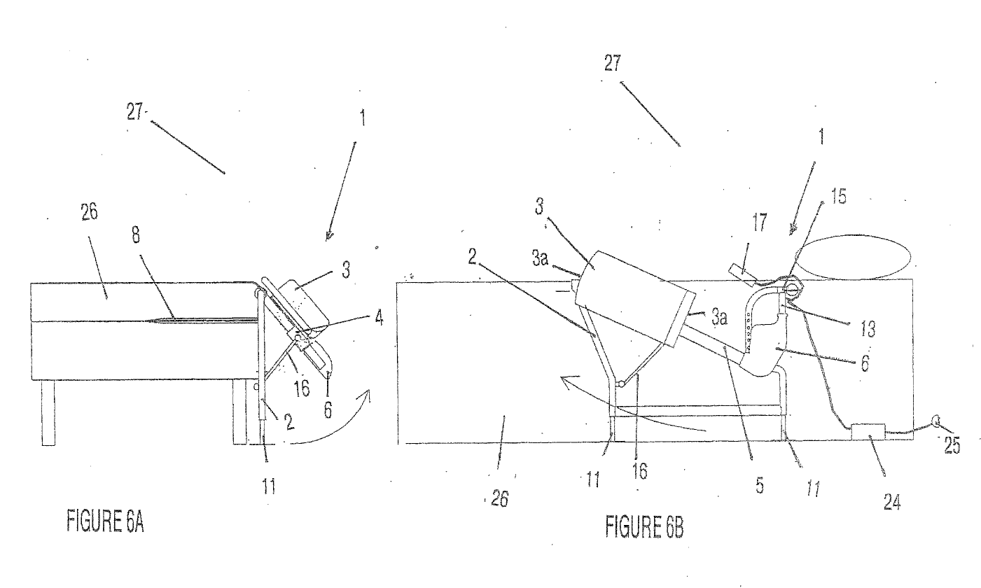

For illustrative purposes, the leg transport apparatus 1 is shown in an intermediate position, between the lowered and raised positions, in FIGS. 6a and 6b. The footrest 3 has been moved part way along the linear guide 5. In practice, the footrest will rotate about the mounting bearing 7 in such a way that the sides 3a remain approximately parallel with the user's legs.

Raising the footrest 3 from a generally vertical lowered position to a generally horizontal raised position moves the user's legs from a sitting position beside the bed, to a position whereby the user's feet are adjacent to the upper surface of the bed. The user need only then slide or lift their feet from the footrest 3 onto the upper surface of the bed.

The process may be reversed to assist the user in getting out of bed, whereby the user may place their legs on the footrest 3 in the raised position adjacent to the upper surface of the bed, then issue an operating command using the remote control handset 17 to lower the footrest 3 to the generally vertical lowered position beside the bed. The pivotal mounting of the footrest 3 relative to the carriage 4 allows the footrest to rotate as the apparatus moves between the lowered and raised positions.

Preferably the lift control arm 16 is telescopic, so that the transport means and footrest 3 can always be raised manually from its lowered position without use of the actuator, allowing the user to free his or her legs, clothing, or anything else which may get caught, if required. Also, if the arm 13 encounters an obstruction when being lowered, then the telescoping action of the control arm prevents the obstruction being entrapped.

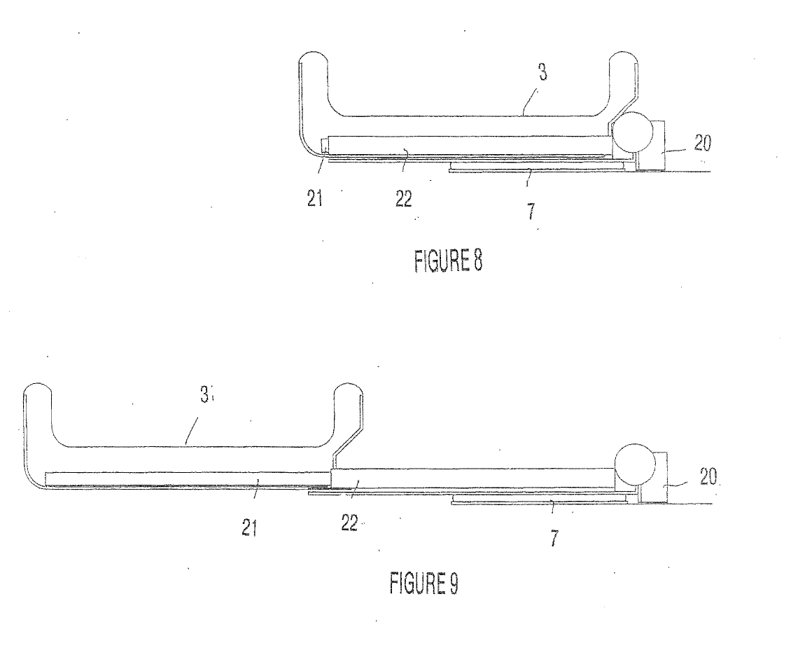

Turning now to FIGS. 8 and 9, an alternative embodiment of a leg support having an extension function is shown. The leg support of this embodiment may also be used in the other embodiments of the invention. In this embodiment the swivel bearing or swivel plate 7 provides a base portion of the support and includes an actuator 20 which includes an elongate arm 21 that extends from a tube 22 or rail (preferably a worm gear drive arrangement). The arm 21 is connected to the footrest 3 so that the actuator 20 is operable to extend or retract the footrest 3 across the upper surface of the bed. Thus this embodiment can be used in place of the leg support described above with reference to FIGS. 1-4.

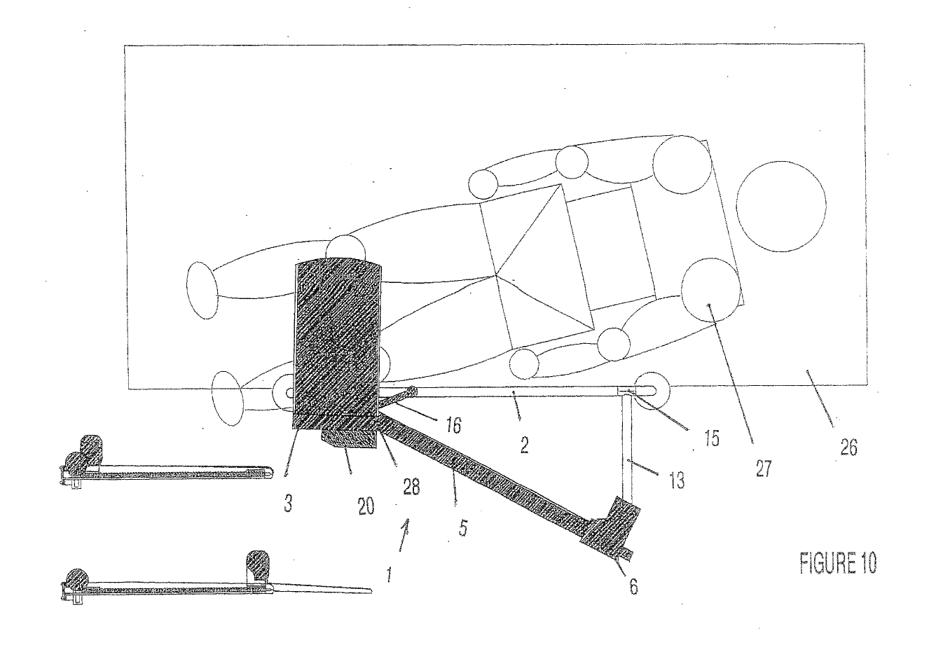

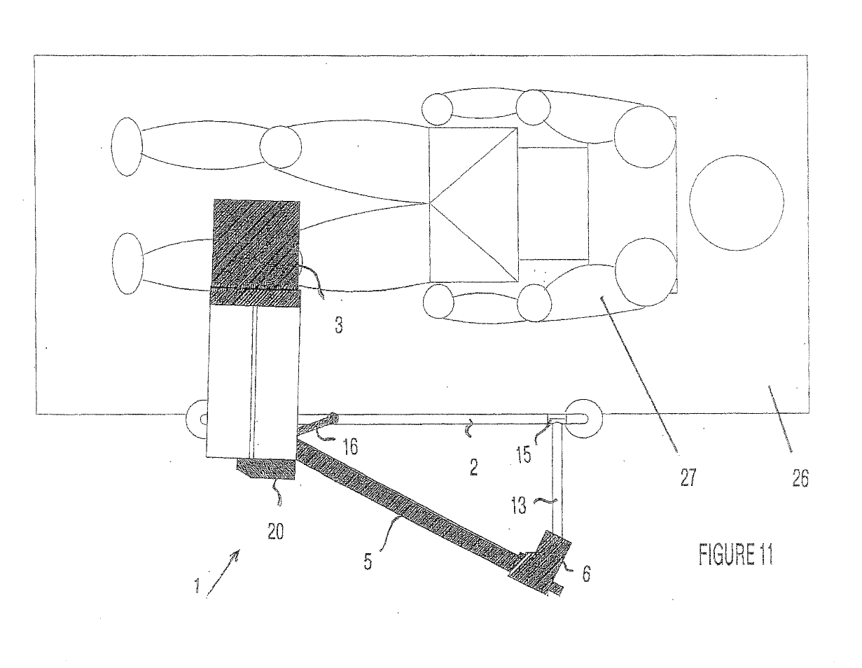

Referring now to FIGS. 10 and 11, plan views of a leg lifting apparatus incorporating the alternative leg support are represented diagrammatically, again in conjunction with a bed 26 and a user 27 of the bed leg lifting apparatus 1. The leg support 3 includes the further actuation means 20, whereby the footrest 3 may be extended towards the centre of the bed's upper surface to further assist the user in getting onto or off abed. Referring to FIG. 10, the footrest 3 is shown in a retracted position. By manipulating the remote control handset 17, the user's legs may be transported towards the centre of the bed by extending the footrest 3 towards the position shown in FIG. 11, and similarly retracted to the position illustrated in FIG. 10. A sheet material 28 preferably having a low coefficient of friction, may be provided about a part of the footrest, to allow the user's feet or lower legs to slide easily off the footrest so that they lie on the folded sheet material. When the footrest is withdrawn the sheet material slides out from under the user's feet.

Use of the bed leg lifting apparatus therefore comprises the steps of a user sitting on the bed as shown in FIGS. 5a and 5b by placing his or her legs such that the user's feet or lower legs are in front of the footrest 3, issuing an operating command using the remote control handset 17 to activate the actuator which causes the footrest or support 3 to move from the lowered vertical position to the raised horizontal position adjacent to the upper surface of the bed, as shown in FIG. 10, then optionally activating the further actuation means 20 using the remote control handset 17 to extend the footrest 3 towards the centre of the upper surface of the bed, as illustrated in FIG. 11. Alternatively, the bed leg lifting apparatus 1 may be adapted to automatically extend the footrest 3 upon reaching the generally horizontal raised position, and similarly retracting the footrest 3 before returning the leg support to the lowered position. Again, the process is reversed to assist the user in getting out of bed.

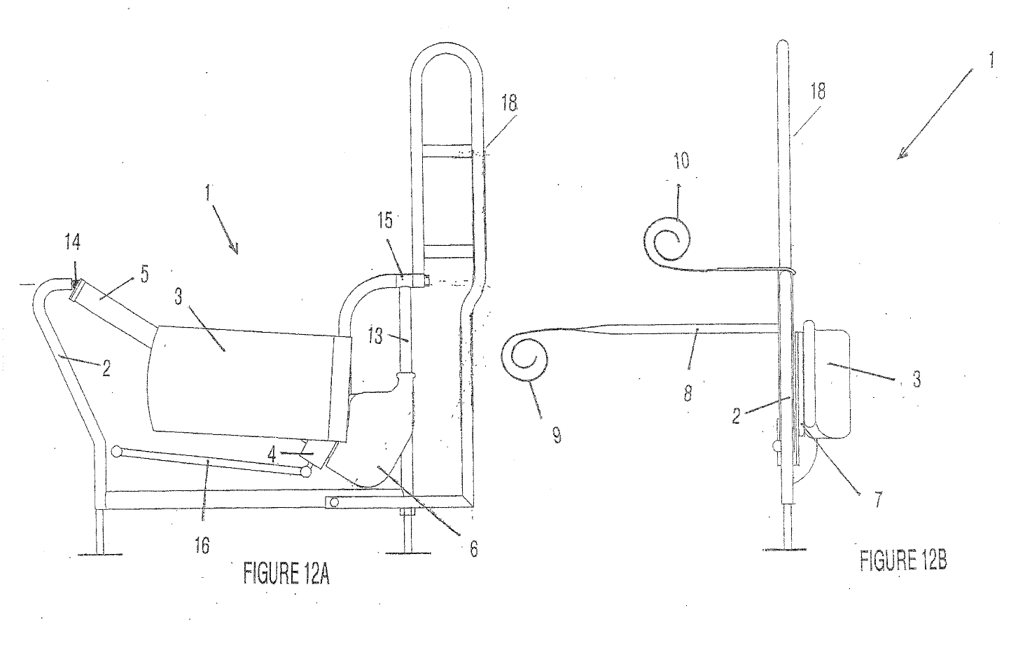

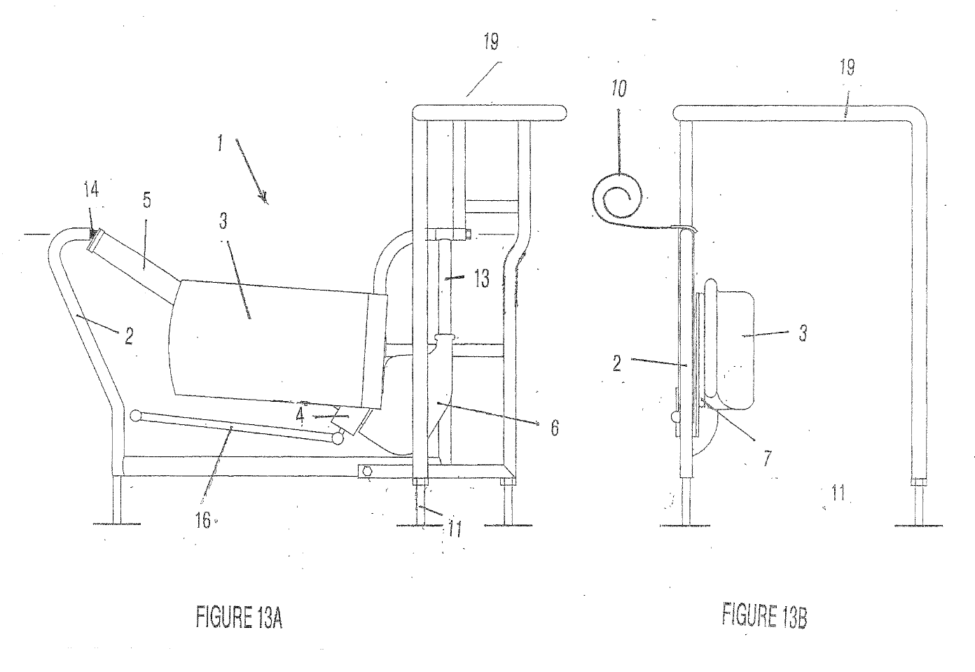

Referring to FIGS. 12a and 12b, a bed leg lifting apparatus 1 according to the invention is shown fitted with an optional grab handle 18. The substantially vertical grab handle 18 may be used to support the user when sitting on or standing up from the bed, and during operation of the leg lifting apparatus 1.

FIGS. 13a and 13b show a bed leg lifting apparatus 1 according to the invention, fitted with an optional transfer rail 19. Similar to the grab handle 18, the transfer rail 19 may be used for support. Unlike the grab handle 18, however, the transfer rail 19 extends transversely to the bed, providing a rail by which the user may support themselves when walking to and from the bed, and turning around before sitting on the bed.

The transfer rail 19 includes a height-adjustable foot 11. The lateral support the transfer rail 19 provides to the bed leg lifting apparatus 1 means that the stability bar and top strap may be omitted or removed in this embodiment.

The base frame 2 is therefore preferably provided with an attachment means, such as bolt holes, to allow the secure attachment of optional components such as the grab handle 18 and/or transfer rail 19.

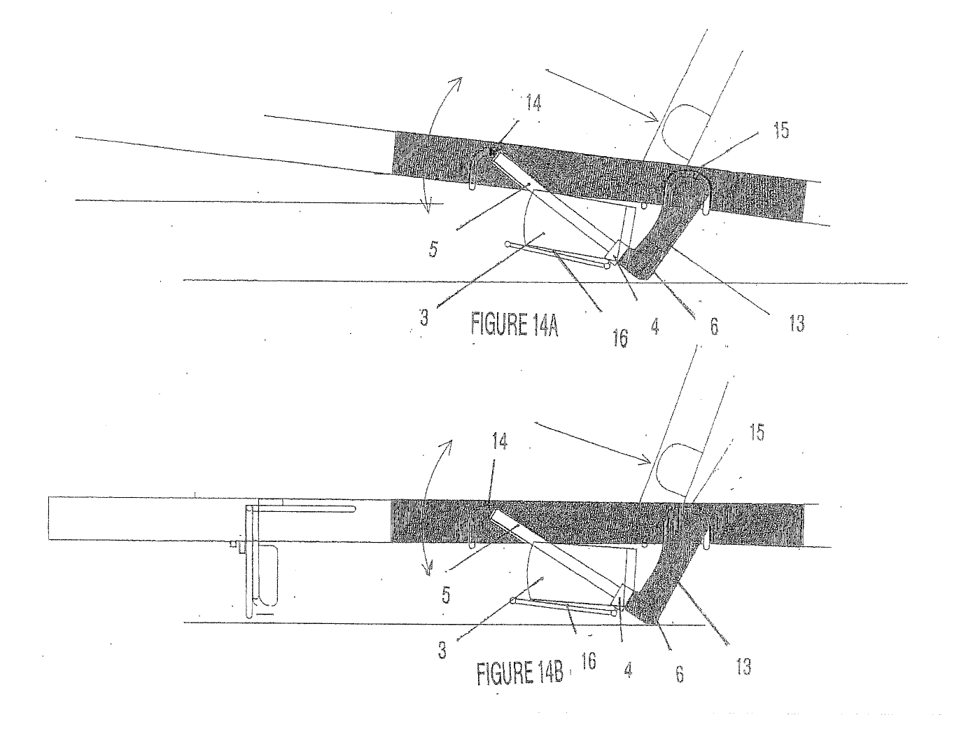

Turning now to FIGS. 14a and 14b, another embodiment of the invention is shown. In this embodiment, like reference numerals are used to denote like features described above with reference to FIGS. 1-13b.

The apparatus is shown fitted to a profiling bed having recesses within the mattress and frame to hide and/or omit some of the leg lifter components, such as the base frame and feet. This allows the leg lifting apparatus 1 to be mounted substantially flush with the side of the bed, allowing the user better access to the seated position on the bed.

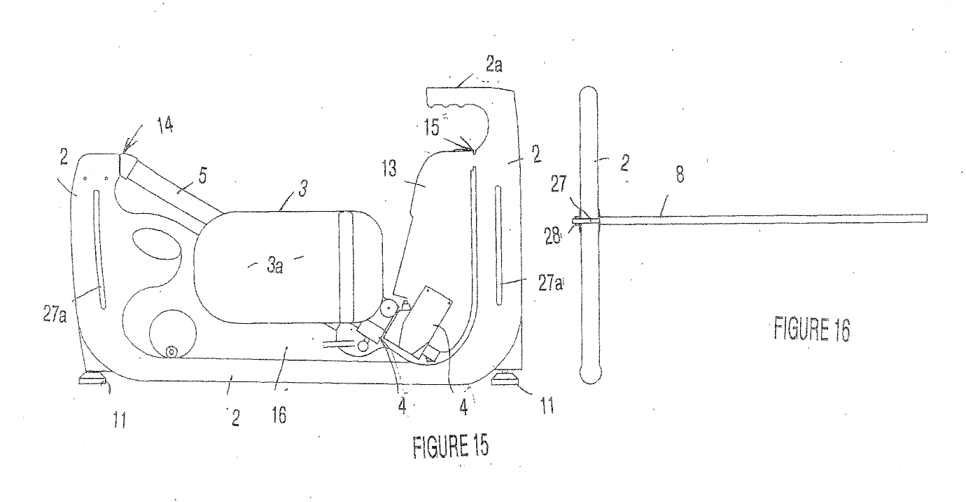

Referring now to FIGS. 15 to 17, a further embodiment of the invention is illustrated. Features of this embodiment that are similar to those of the other embodiments described are denoted using the same reference numerals. Therefore to avoid repetition, the only new features of this embodiment will be described in detail. The feature of this embodiment is that the support frame 2 and lift arm 13 incorporate are partly or wholly moulded from a suitable material such as plastic. In a preferred embodiment the process may be rotational moulding, but other processes may be used. Also the moulded parts are preferably such that the steel frame parts described in the previous embodiments are no longer required. Thus, bearing support sleeves or similar apparatus may be provided as inserts in the moulds and the plastic moulded about them so that the pivot points 14 and 15 can be provided in the finished article. A similar process can be employed to provide height adjustable (via threaded engagement) feet 11. Also, the moulded frame 2 and lift arm 13 are constructed such that the actuator assembly and leg support can be mounted on the other side of the apparatus to allow the apparatus to be mounted on the left or right hand side of a bed. This means that a further set of moulds (and component inventory) is not required. In a preferred embodiment a “boot” or sleeve of flexible or resilient material is provided over the control arm 16.

As can be seen in FIGS. 16 and 17, a stability bar 8 having a threaded connector 27 is easily placed in one or each of slots 27a, and fixed in place using nuts 28.

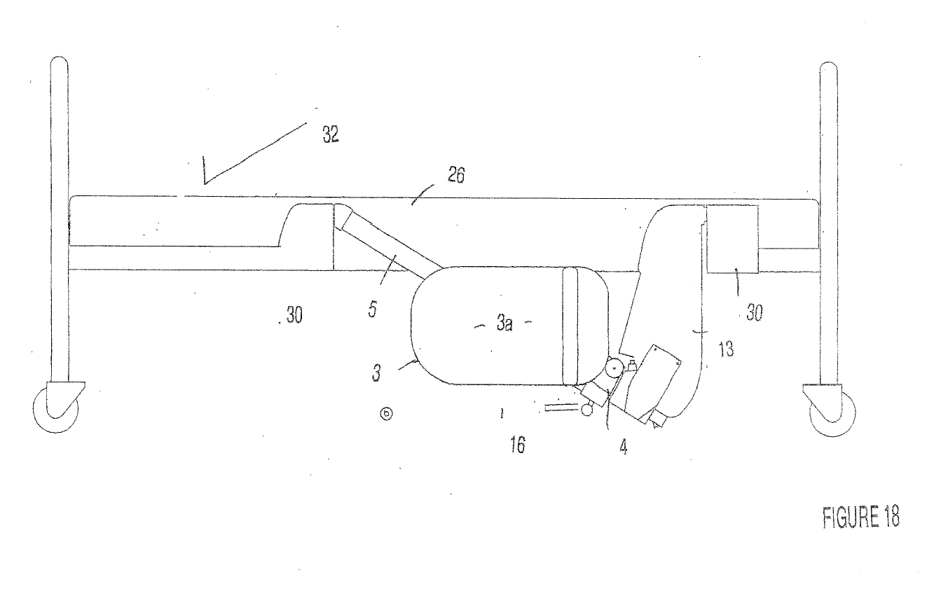

In FIG. 18 the embodiment of FIGS. 15 to 17 is shown built as part of a profiling bed 32. The bed frame has parts 30 to which the pivot connections 14 and 15 are made so the frame 2 is not required and the control arm is connected between the carriage and a part of the bed frame. As mentioned above, the lift arm 13 is moulded to allow the actuator assembly and leg support to be mounted on either side, so that the leg lifter apparatus as a whole is easily built onto either side of the bed.

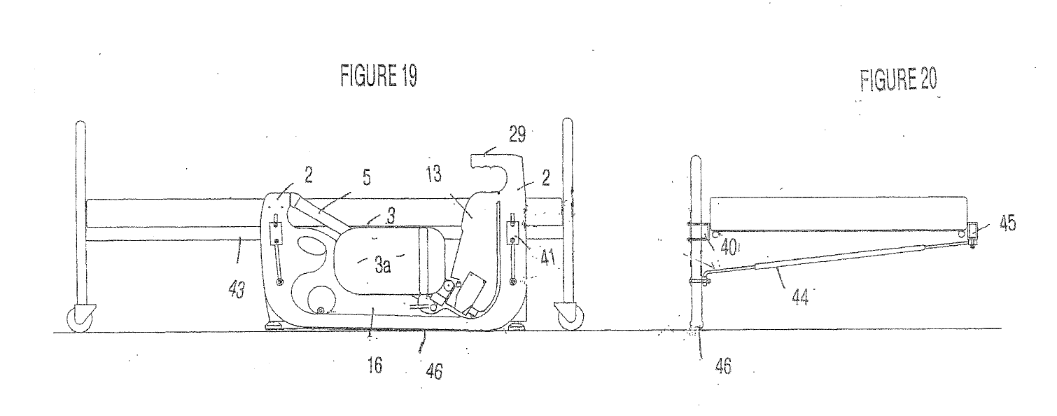

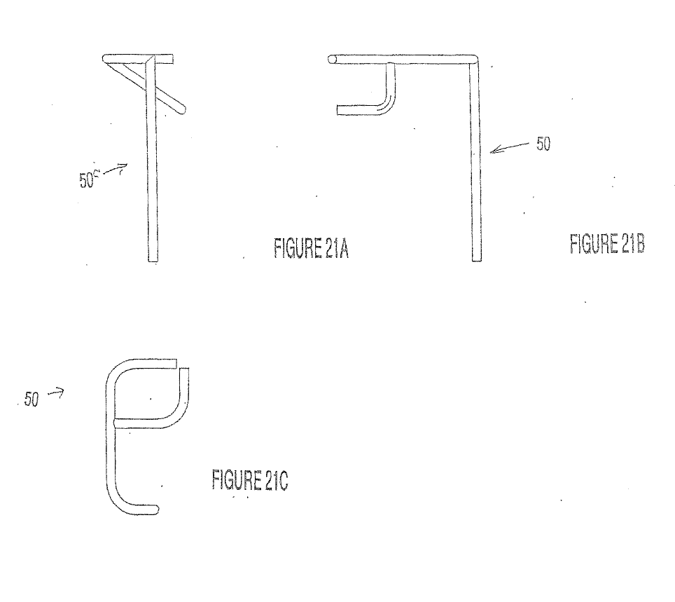

In FIGS. 19 and 20 the embodiment of FIGS. 15 to 17 is shown fixed to a profiling bed. A U-bolt 40 and nuts over flat washer 41 engage the frame 2 with a near rail 43 of the bed frame. An adjustable length rod 44 may be used if necessary to further support the frame 2 by connecting it to a far bed rail 45. This allows the leg lifter apparatus to move up and down with the bed as the bed is adjusted in height. A microswitch 46 is preferably provided along the base of the frame 2 which terminates the “down” movement function of the bed when pressure is encountered in order to prevent objects (such as toes) being trapped between the frame 2 and the floor. To assist a user the controller used to raise or lower the

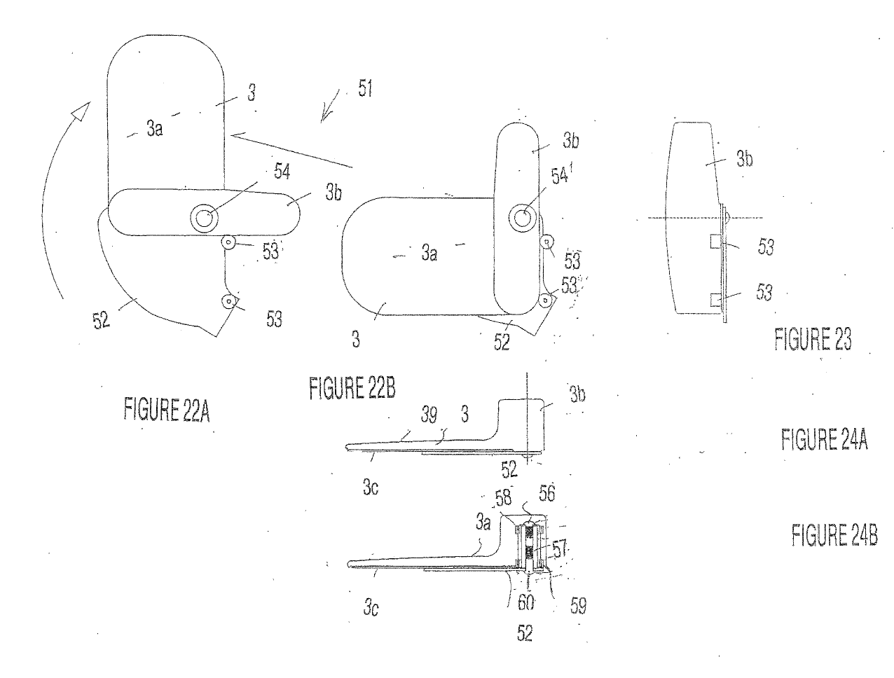

The embodiment of FIGS. 15 to 17 includes a handle 2a which may be used to transport the apparatus. This may also serve as a handle for a user to support his or her upper body during a leg raising or lowering operation. However, a further handle 50 such as that shown in FIGS. 23a-23C may also be used. Handle 50 can be attached to the bed or to the frame 2 adjacent to the end of frame 2 that carries handle 2a.

Turning now to FIGS. 22 to 26, a leg support assembly 51 is shown that may be used with any of the foregoing embodiments. The support assembly allows the leg support 3 to extend over the upper surface of the bed so that the user's leg(s) are conveniently located over a substantially central position of the upper surface of the bed at once the leg lifter apparatus is in its fully raised position. Therefore, the user does not need to shuffle his or her leg(s) transversely across the bed to assume a normal bed rest position.

The leg support assembly 51 comprises the leg support or footrest 3 which is hingedly connected to a base 52 by a hinge assembly 54. The leg support 3 includes a fence or buttress 3b which in use contacts the side of a leg of the user to thereby facilitate turning of the support 3 about hinge 54 to allow the support 3 to extend from the base 52 as shown in FIG. 22A. Projecting stop members 53 are positioned to contact the fence 3b at selected angular positions of the fence relative to the base in order to limit the extent of rotation of the support 3. In one embodiment, a lower surface 3c of the support 3 is coated with a low friction material such as a low friction plastic sheet to facilitate rotation of the leg support 3 relative to the base 52.

The construction of hinge 54 is shown in greater detail in FIG. 24B. An axle 57 includes a tapered bearing 58 at an upper end and another tapered bearing 59 at the lower end. The axle 57 is secured to the support 3 and the base 52 respectively by fixing bolts 56 and 60.

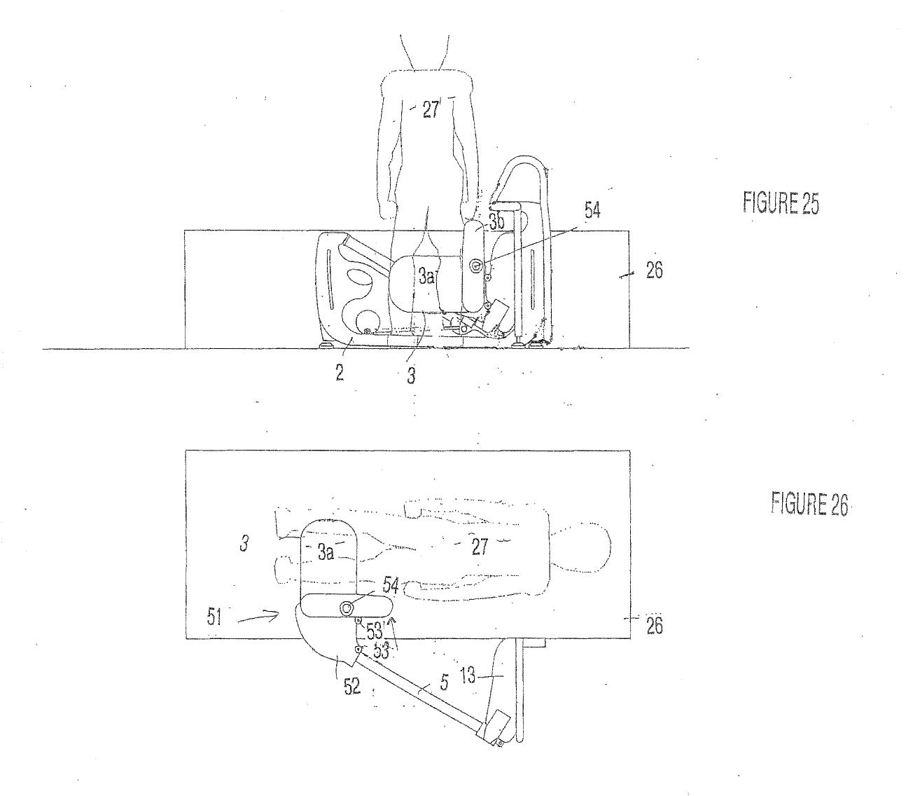

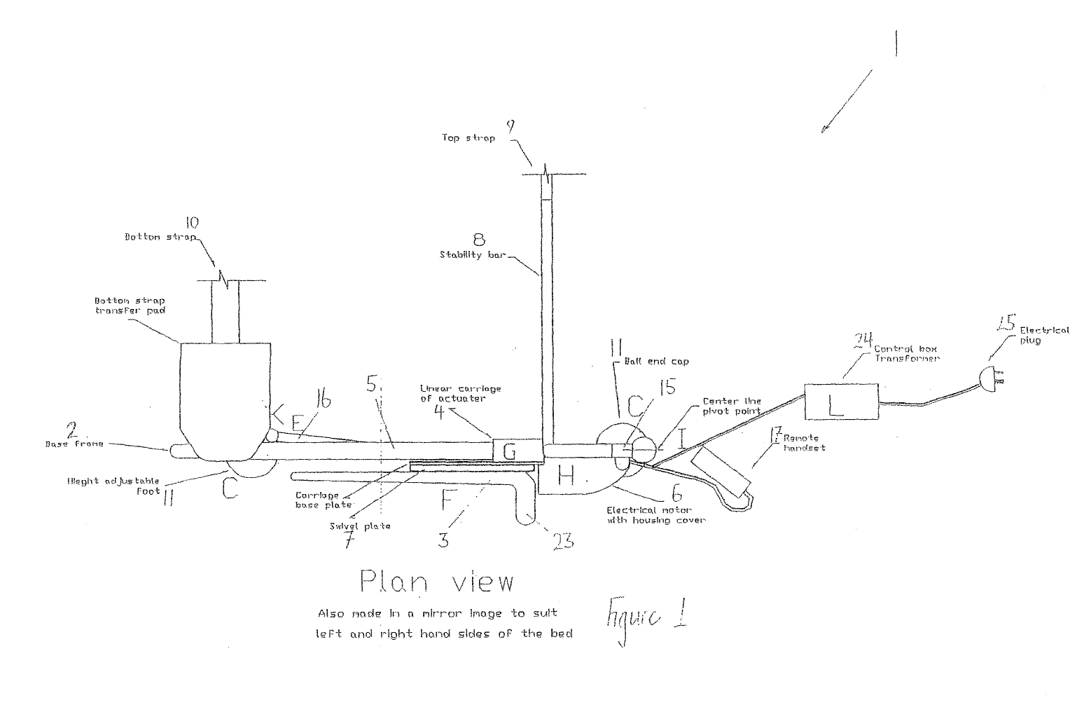

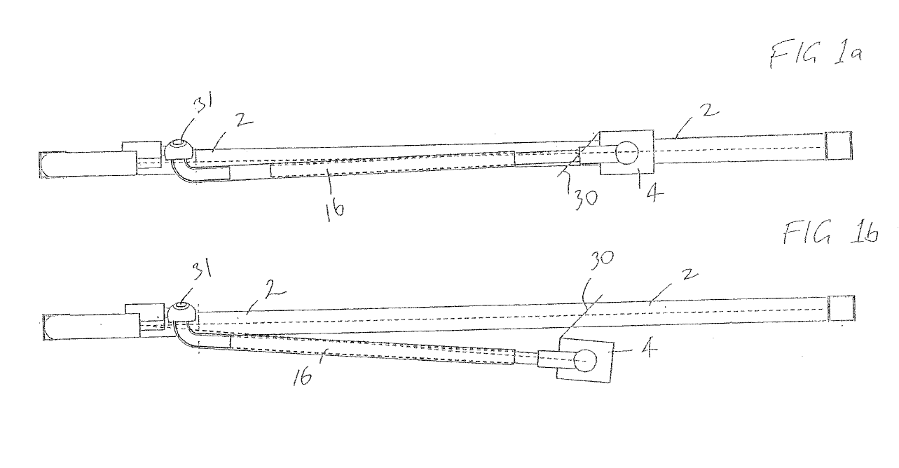

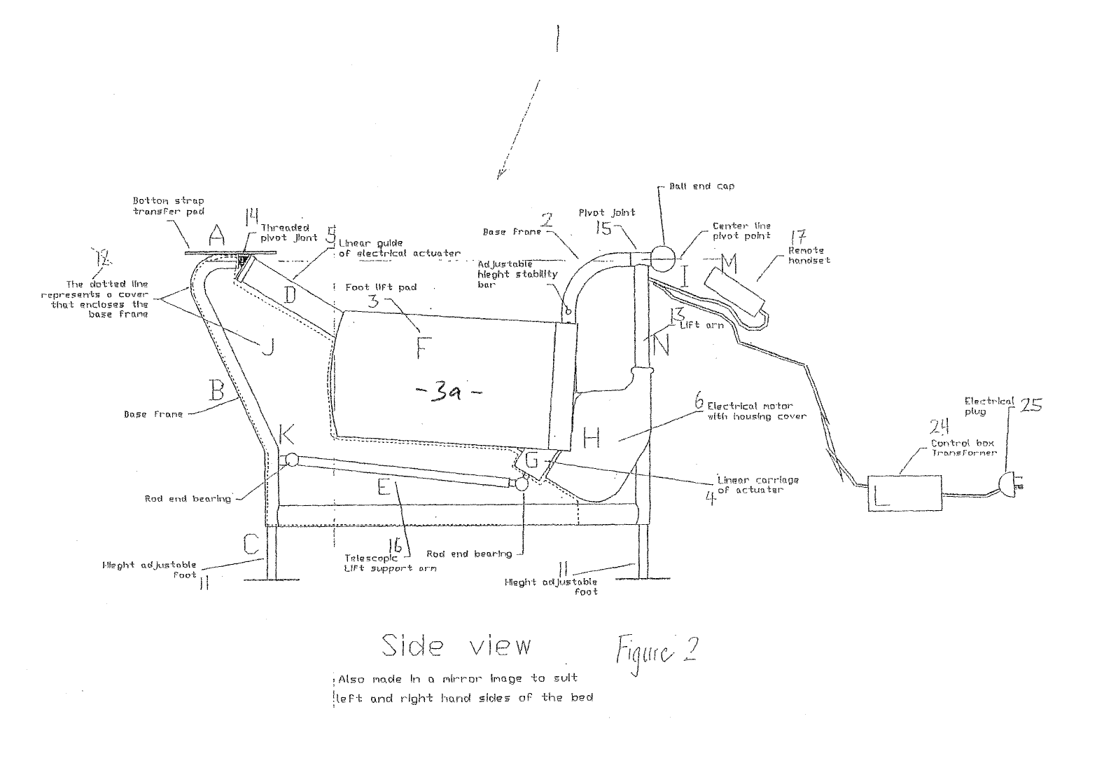

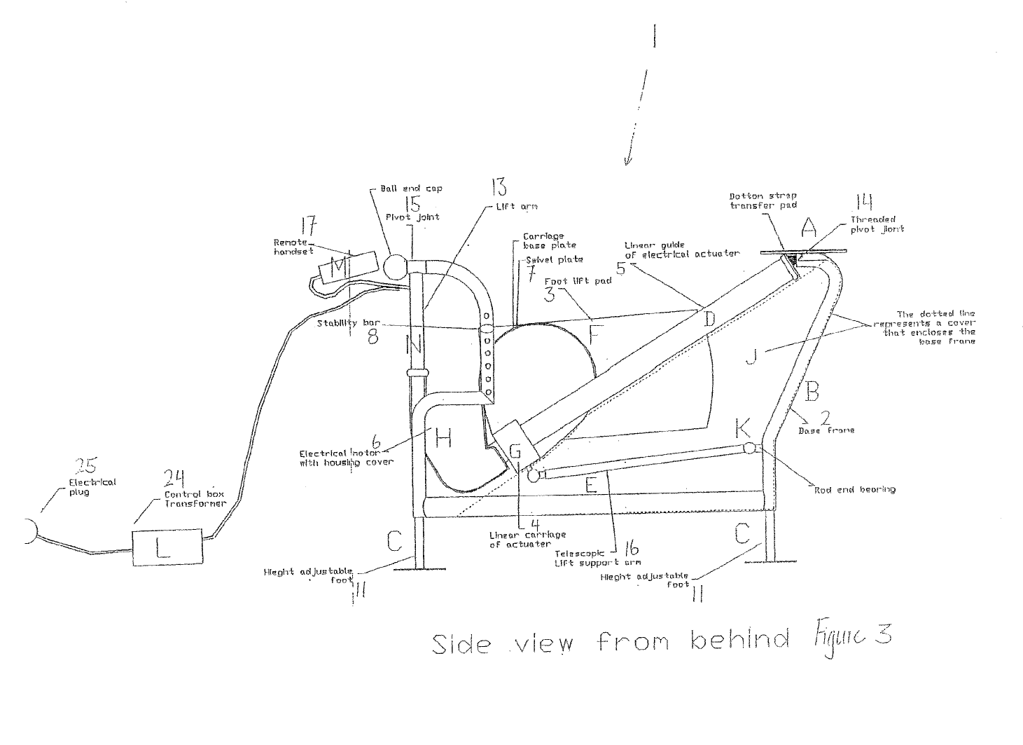

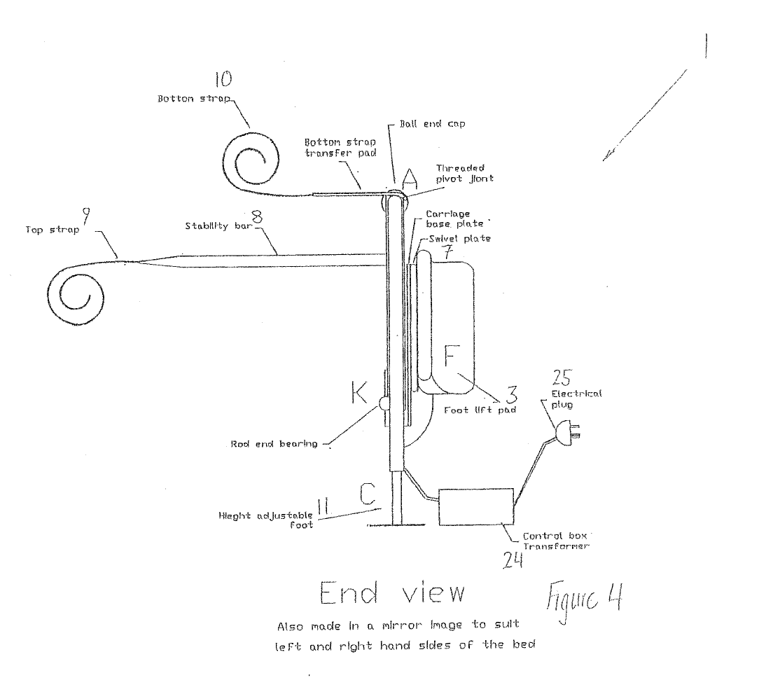

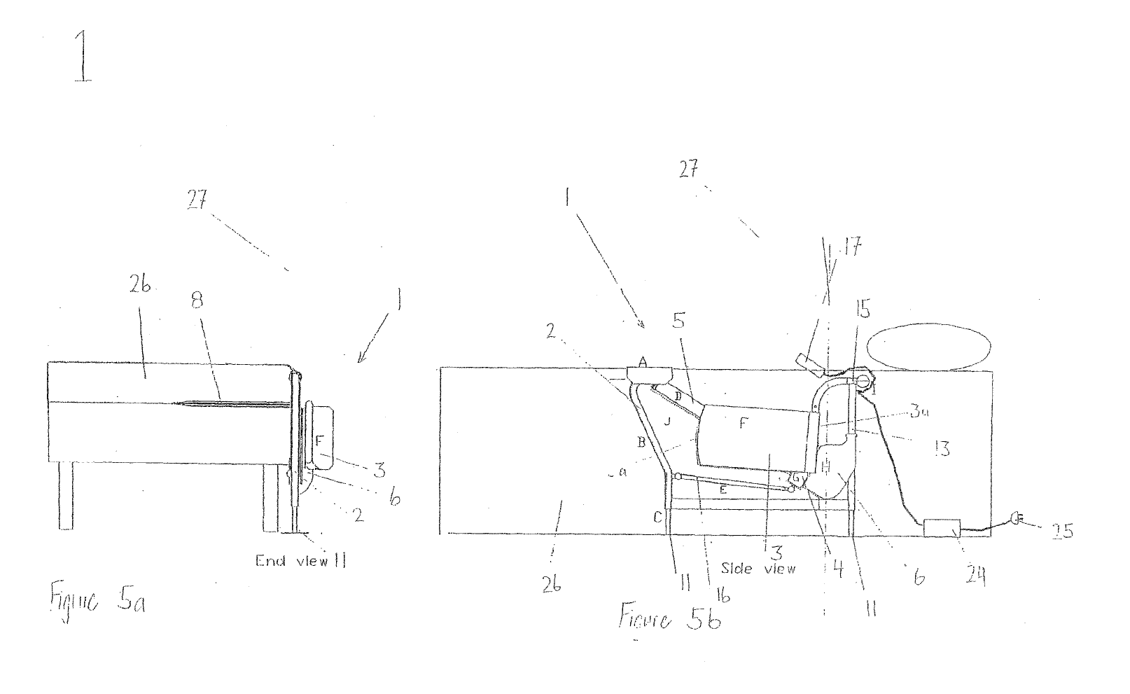

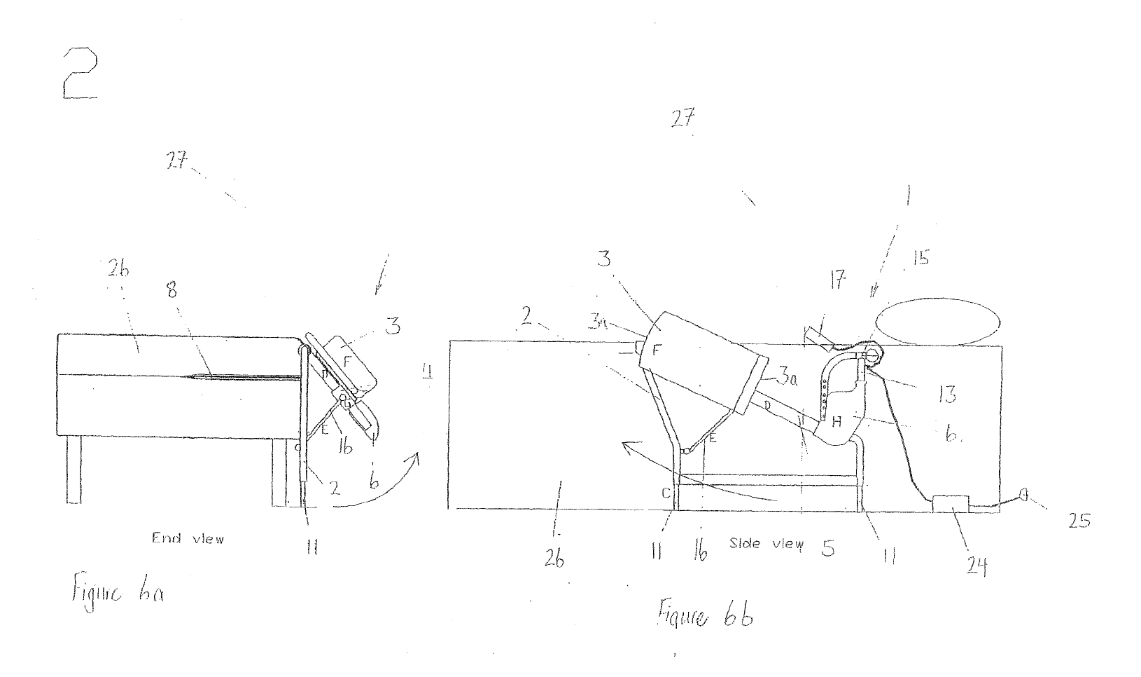

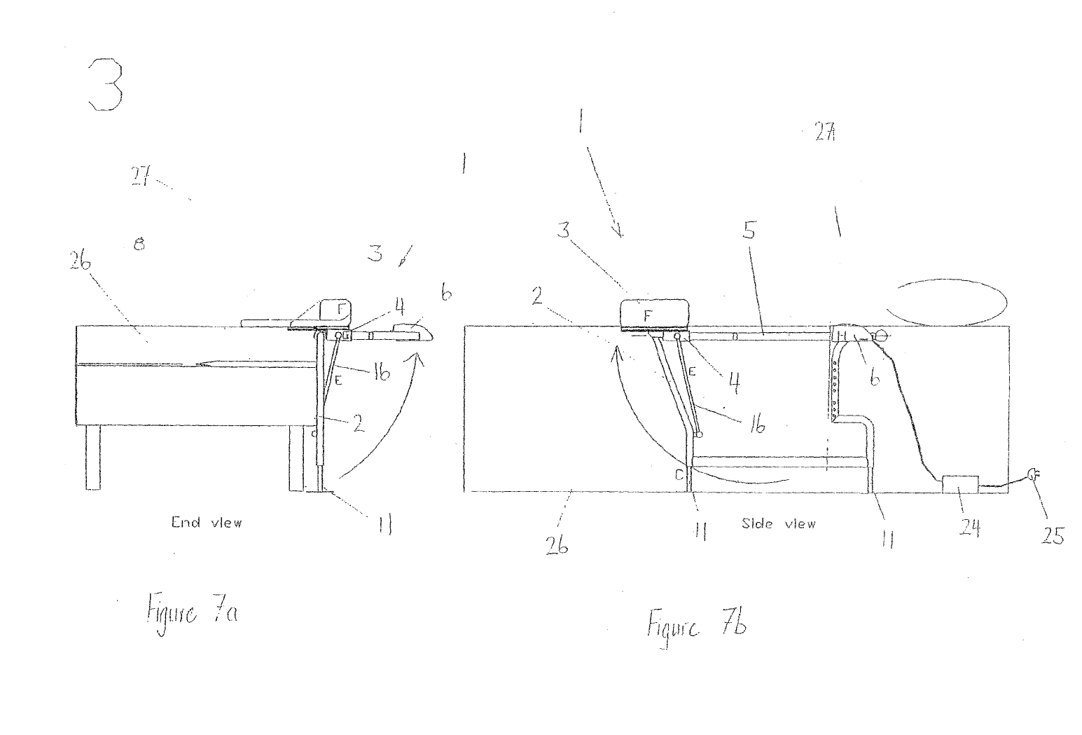

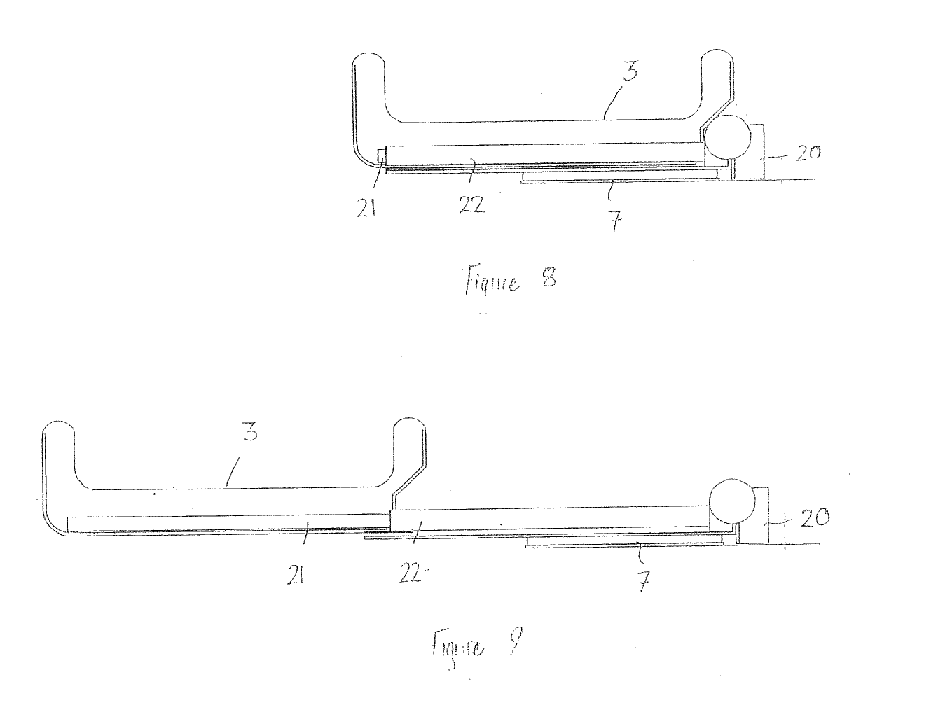

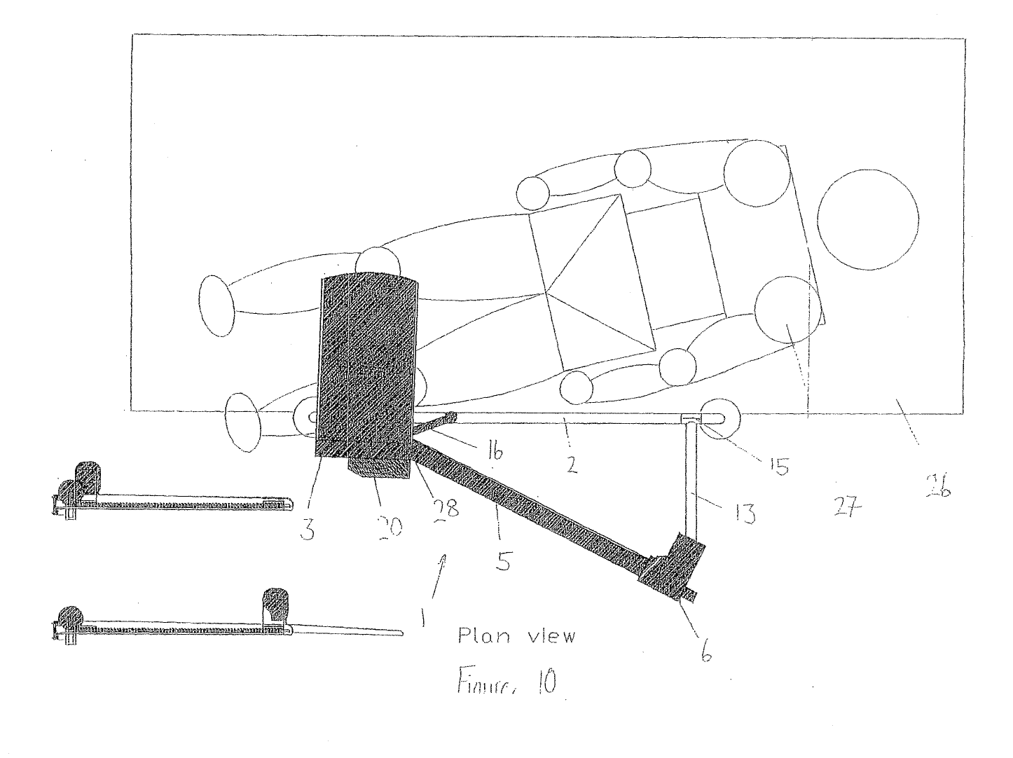

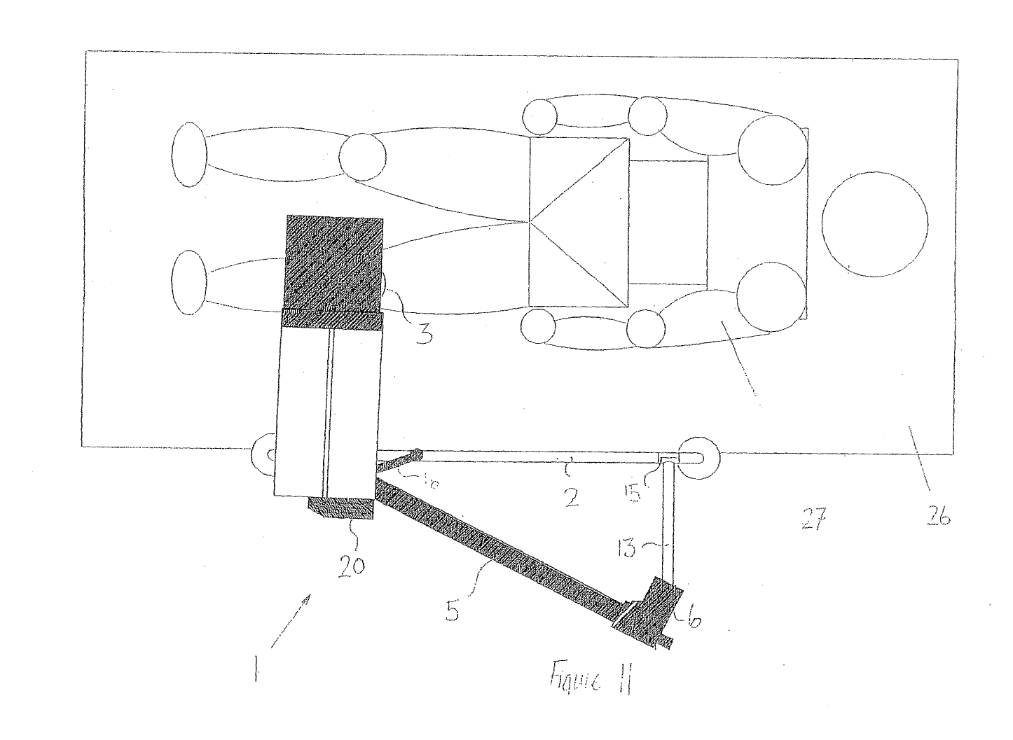

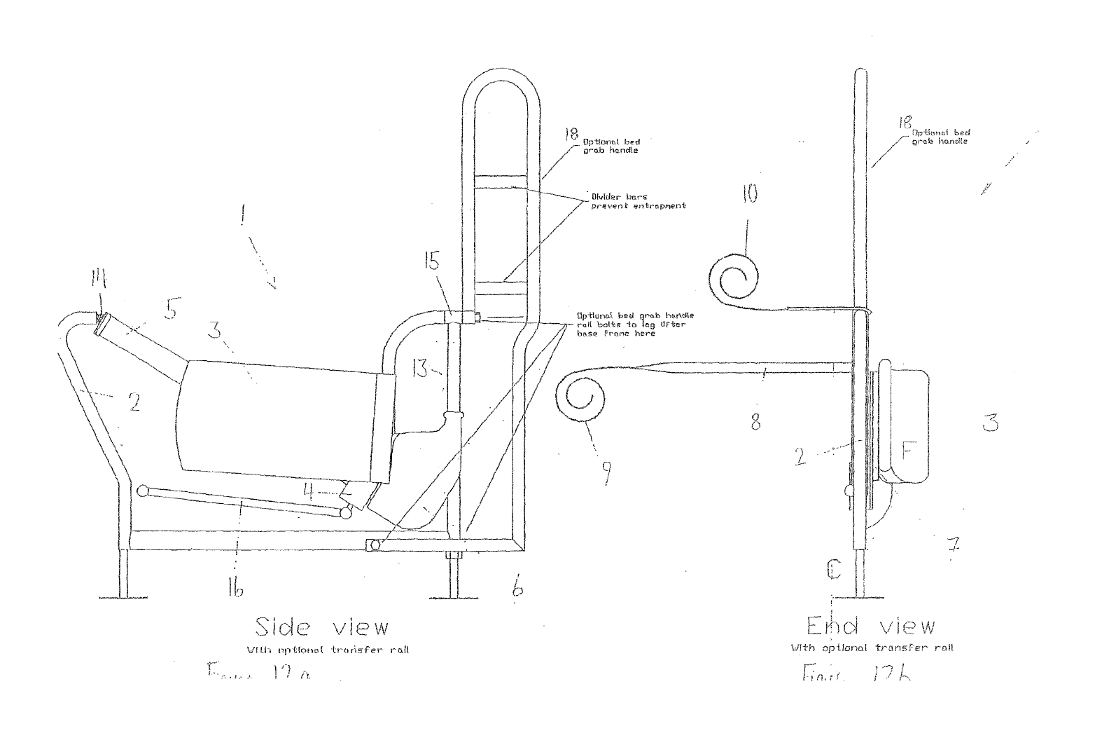

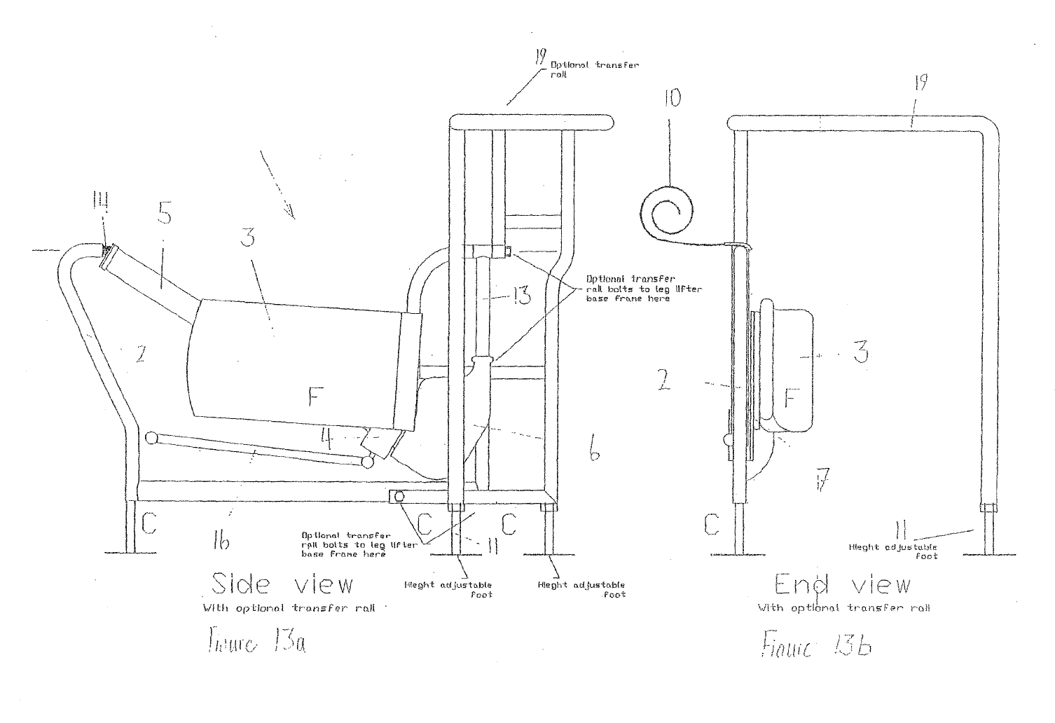

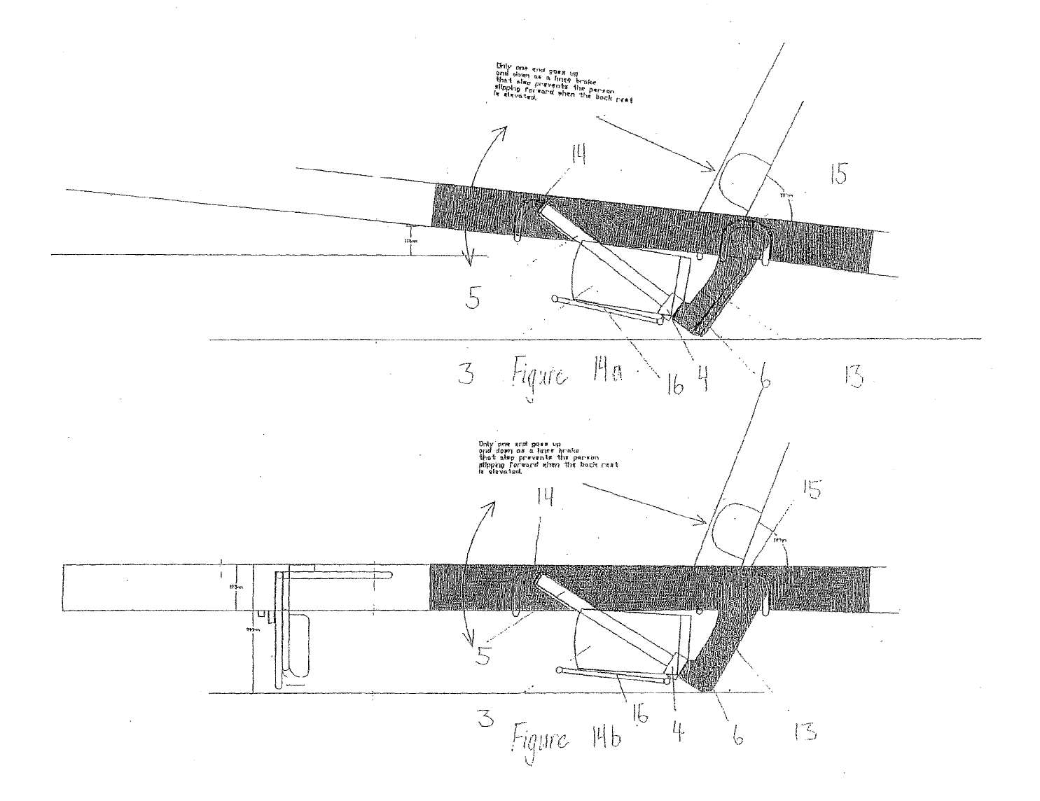

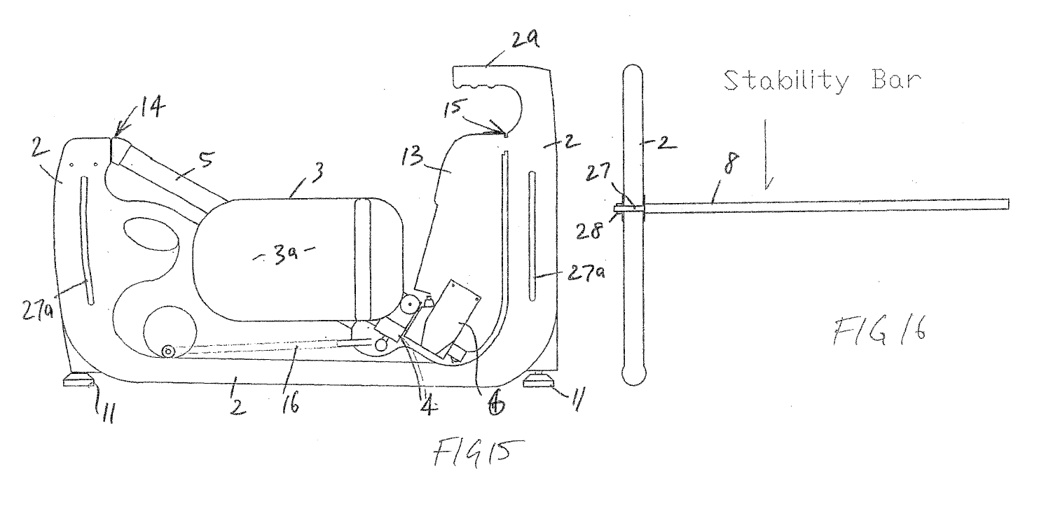

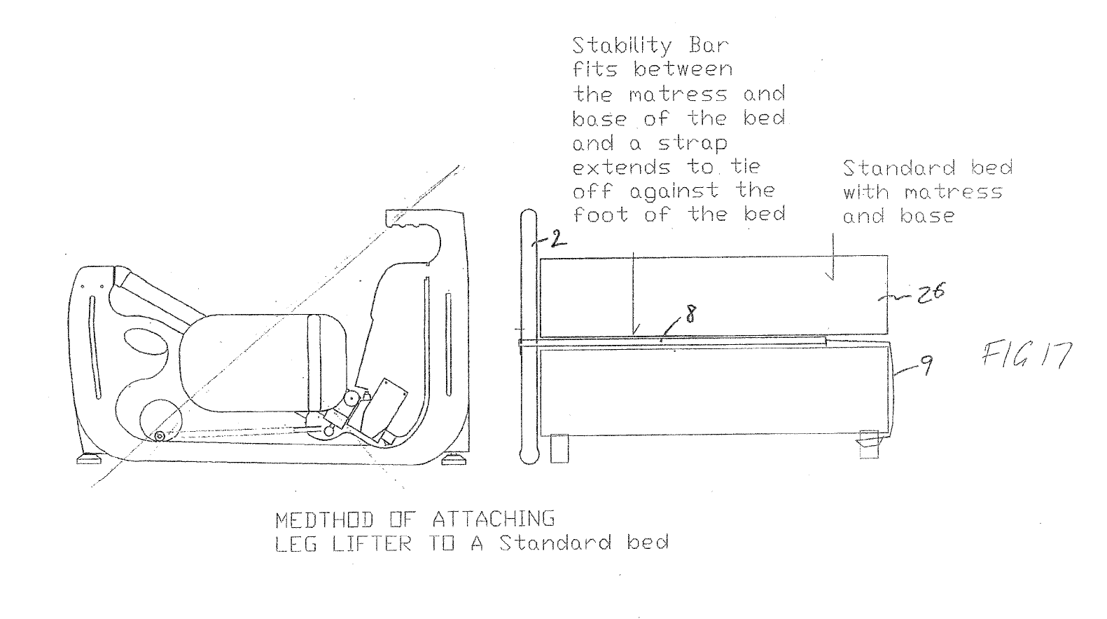

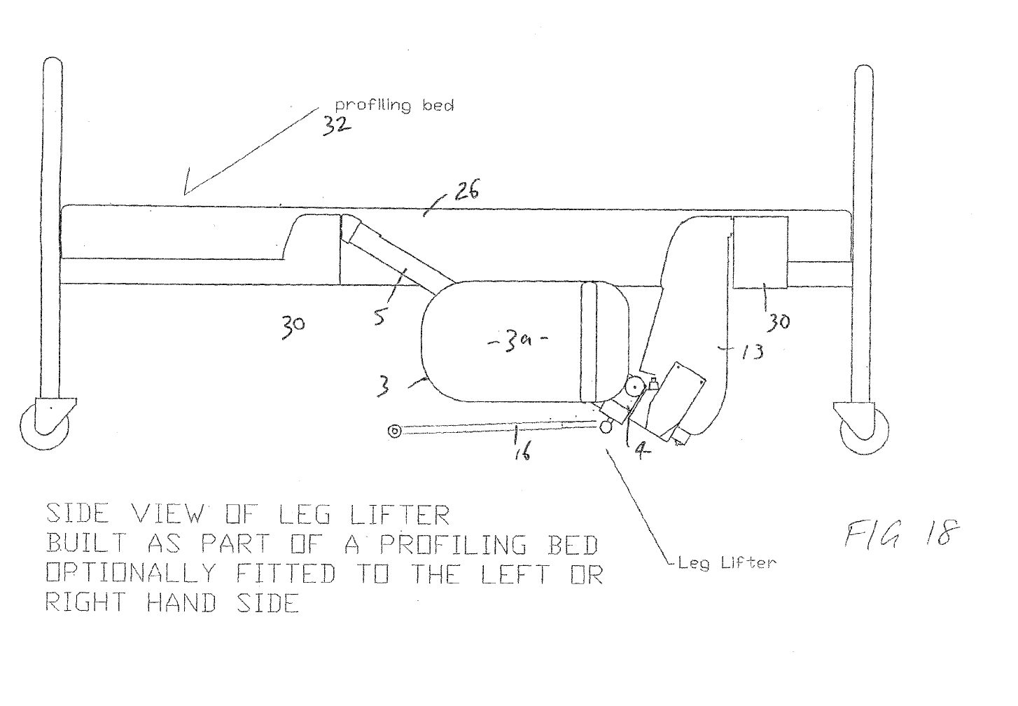

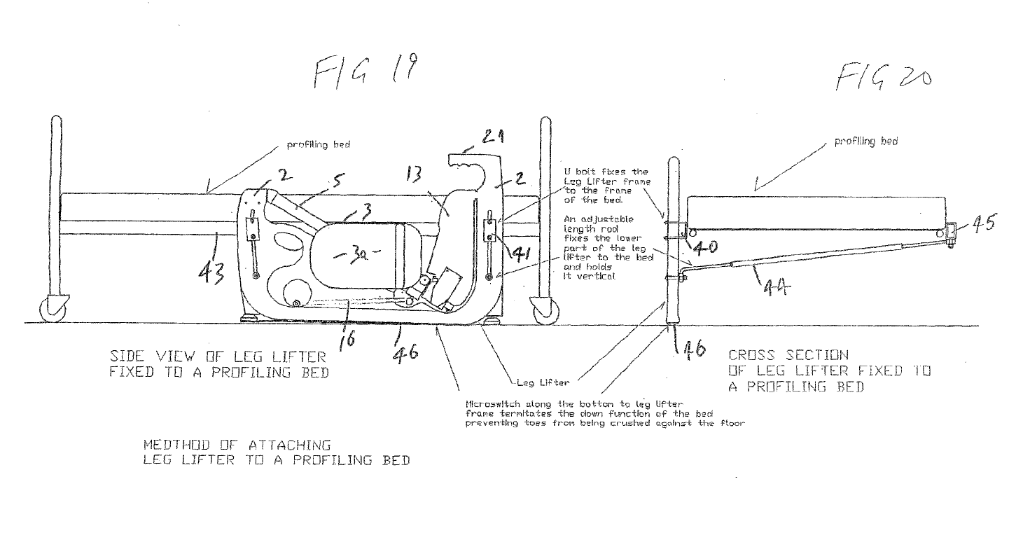

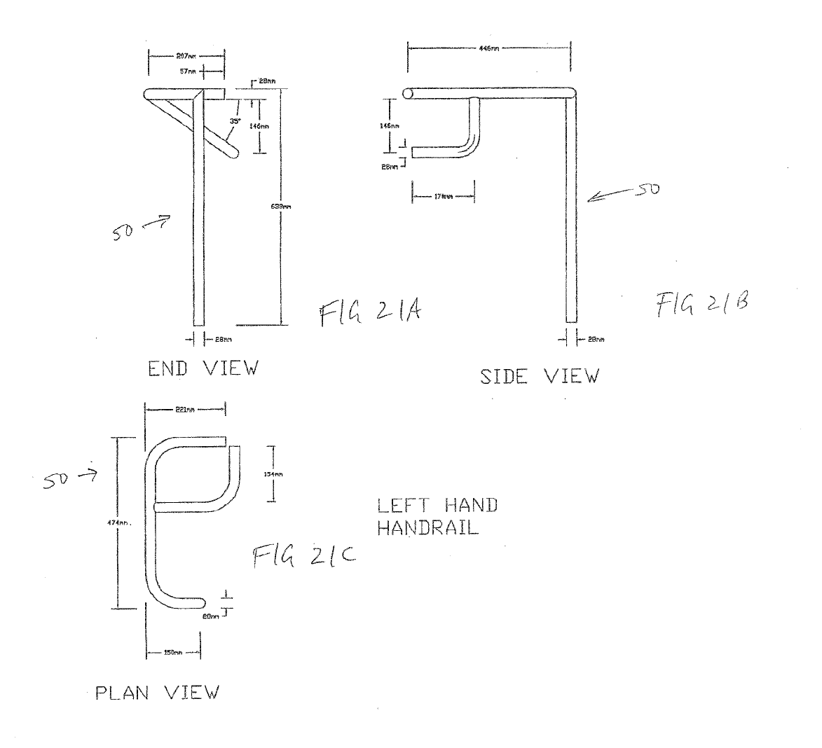

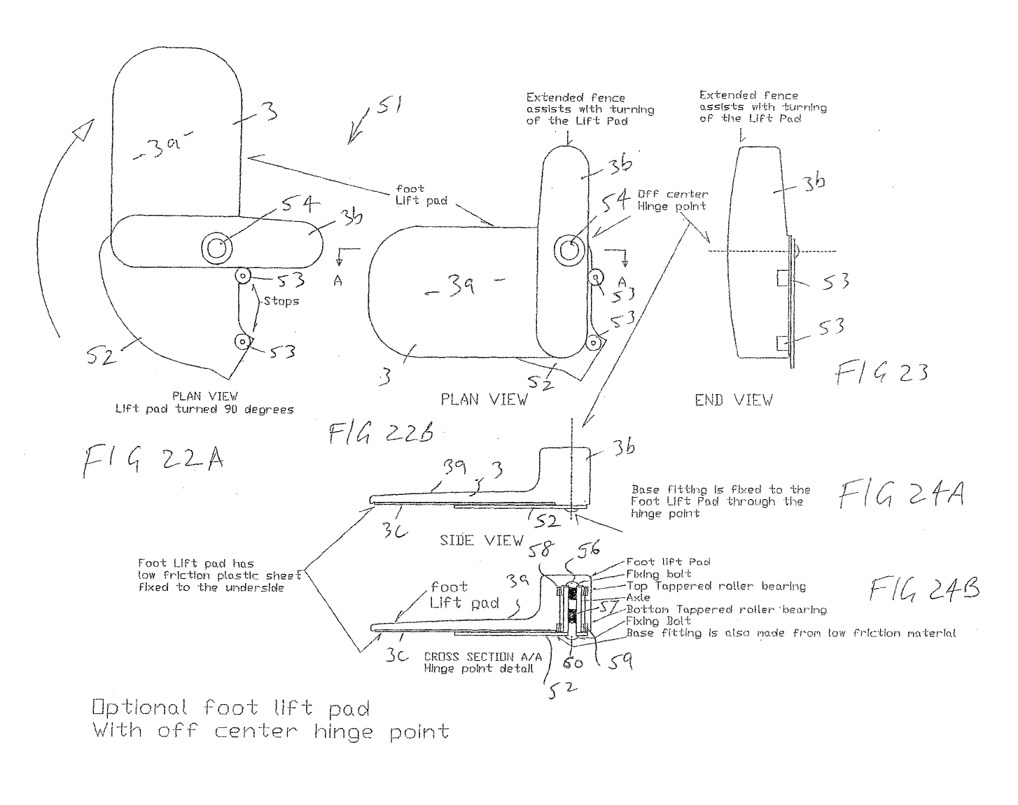

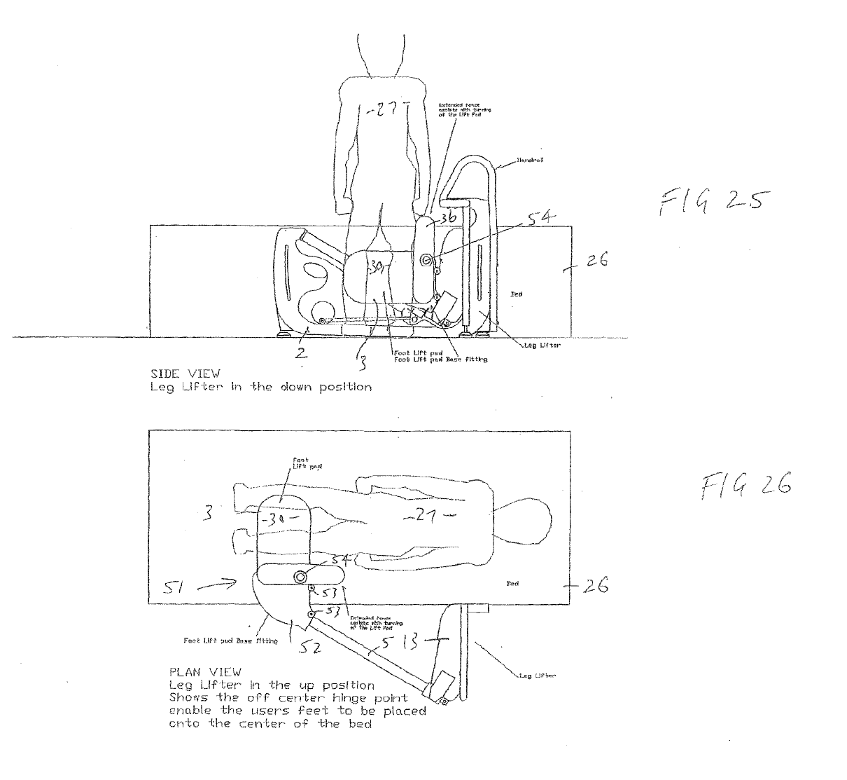

FIGS. 25 and 26 show the leg lifting apparatus of FIGS. 15 to 17 fitted with the leg support assembly 51. In FIG. 25 the apparatus is shown in the lowered position in which the leg support 3 is positioned over the base 52. In FIG. 26 the apparatus is in the raised position in which it can be seen that the support 3 has been rotated about hinge 54 to extend from base 52 so that user's legs are in a substantially central position over the upper surface of the bed. Thus the user needs to only slide his or her legs across upper surface 3a of the support 3 to adopt a normal bed rest position.

From the foregoing it will be seen that an apparatus is provided to allow a users legs to be transported from a position at the side of a bed onto an upper surface of the bed. In particular, the apparatus allows a single actuator to perform both a lateral sliding function and a pivoting function to move the leg support 3 between the required lowered and raised positions. The pivoting action is achieved by use of the control arm 16. Those skilled in the art will appreciate that the actuator and control arm components may be reassembled in other configurations to achieve the same result. For example, the actuator may be provided on the support frame rather than the pivoting part of the apparatus, and move the leg support slideably through an appropriate linkage. A control arm between the leg support and the support frame may still be used to effect the pivotal or rotational movement of the leg support. Also, the pivotal mounting of the control arm on the leg support and/or the support frame may be such that the pivotal mounting slides relative to the leg support and/or the support frame.

Where in the foregoing description reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the spirit or scope of the invention.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

1-19. (canceled)

20. Leg transport apparatus for transporting or moving a user's leg(s) onto or off a bed, the apparatus comprising
a support frame adapted to attach to a bed, or comprising part of a bed;
a leg support for supporting the leg(s) of a user, the leg support having a leg support surface and being slidably and pivotally mounted relative to the support frame;
an actuator means operable to move the leg support slidably relative to the support frame; and
a control arm pivotally connected between the leg support and the support frame whereby slidable movement of the leg support relative to the support frame causes pivotal movement of the leg support relative to the support frame such that the leg support can be disposed in a lowered position in which the leg support surface is substantially vertical for receiving the lower leg(s) of a user, and a raised position in which the leg support surface is substantially horizontal and laterally displaced from the lowered position to dispose the leg(s) of a user substantially adjacent to an upper surface of a bed.

21. Leg transport apparatus as claimed in claim 20 wherein the actuator means comprises a single actuator.

22. Leg transport apparatus as claimed in claim 20 wherein the actuator means includes a guide and a carriage is mounted on the guide to move along the guide and the leg support is linked to the carriage.

23. Leg transport apparatus as claimed in claim 22 wherein the control arm is connected between the frame support and the carriage.

24. Leg transport apparatus as claimed in claim 22 wherein movement of the carriage along the guide means in a first direction causes the leg support to move pivotally away from the frame support to raise the leg(s) of a user from the lowered position to the raised position.

25. Leg transport apparatus as claimed in claim 24 wherein movement of the carriage along the guide means in a second direction causes the leg support to move pivotally toward the frame support to lower the leg(s) of a user from the raised position to the lowered position.

26. Leg transport apparatus as claimed in claim 20 wherein the control arm is telescopic.

27. Leg transport apparatus as claimed in claim 20 wherein the leg support member is extendible.

28. Leg transport apparatus as claimed in claim 27 wherein the leg support member is provided with a further actuation means and driving means to automate the extension and retraction of the footrest.

29. Leg transport apparatus as claimed in claim 20 wherein the apparatus includes means to provide an opening angle between the control arm and the support frame.

30. Leg transport apparatus as claimed in claim 20 wherein the pivotal movement of the leg support occurs in a direction away from the support frame when the leg support moves from the lowered position to the raised position.

31. Leg transport apparatus as claimed in claim 20 wherein the leg support includes a hinge means to allow the leg support surface to extend over an upper surface of the bed when the leg support is in the raised position.

32. A method for transporting or moving a user's leg(s) onto or off a bed, the method comprising providing a leg support on which the user rests his or her leg(s), an actuator and a control arm connected between the leg support and a support frame, and using the actuator to drive the control arm to move the leg support laterally along the support frame and rotate the leg support in a direction perpendicular to the support frame to move the leg support between a first generally vertical lowered position adjacent to a lower side of the bed and a generally horizontal raised position adjacent to an upper surface of the bed.

33. A method as claimed in claim 32 including extending the leg support towards the centre of the bed after moving the leg support to the raised position, and retracting the leg support before returning the leg support to the lowered position.

34. A bed including a leg transport apparatus, the apparatus comprising:
a support frame comprising part of the bed;
a leg support for supporting the leg(s) of a user, the leg support having a leg support surface and being slidably and pivotally mounted relative to the support frame;
an actuator means operable to move the leg support slidably relative to the support frame; and
a control arm pivotally connected between the leg support and the support frame whereby slidable movement of the leg support relative to the support frame causes pivotal movement of the leg support relative to the support frame such that the leg support can be disposed in a lowered position in which the leg support surface is substantially vertical for receiving the lower leg(s) of a user, and a raised position in which the leg support surface is substantially horizontal and laterally displaced from the lowered position to dispose the leg(s) of a user substantially adjacent to an upper surface of a bed.

35. A bed as claimed in claim 34 wherein the bed comprises a profiling bed.

36. Leg transport apparatus for transporting or moving a user's leg(s) onto or off a bed, the apparatus comprising an actuator, a leg support on which the user rests his or her leg(s), and a control arm, the leg support being moveable by slidable lateral movement along a support frame and by pivotal movement relative to the support frame in a direction perpendicular to the support frame, the control arm being connected between the support frame and the leg support, and the actuator being operable to drive the control arm to move the leg support laterally along the support frame and rotate the leg support in a direction perpendicular to the support frame to move the leg support between a first generally vertical lowered position adjacent to a lower side of the bed and a generally horizontal raised position adjacent to an upper surface of the bed.

37. Leg transport apparatus as claimed in claim 36 wherein the leg support is extendable such that it may be extended towards the centre of the bed after moving the leg support to the raised position, and retracting the leg support before returning the leg support to the lowered position.
